(19) United States
(12) Patent Application Publication
(10) Pub. No.: US 2010/0070626 A1
(43) Pub. Date: Mar. 18, 2010

(54) Method And System For Resolving Indeterminate or Inconsistent Information For Information Consumers

(75) Inventors: Brian McCOLGAN, Mississauga (CA); Michael SHENFIELD, Mississauga (CA); Gaelle MARTIN-COCHER, Mississauga (CA)

Correspondence Address: MOFFAT-RIM, 427 Laurier Avenue W., Suite 1200, Ottawa, ON, K1R 7Y2, CA

(73) Assignee: Research In Motion Limited, Waterloo, ON (CA)

(21) Appl. No.: 12/559,145

(22) Filed: Sep. 14, 2009

Related U.S. Application Data
(60) Provisional application No. 61/097,038, filed on Sep. 15, 2008.

(51) Int. Cl. G06F 15/173

(52) U.S. Cl. 709/224

(57) ABSTRACT

A method and apparatus for resolution of indeterminate or inconsistent information on behalf of an information consumer, the method using a processor of a middleware component to determine whether information for the information consumer is resolvable; and if the information is determined to be unresolvable, utilizing at least one of rules, policy types and policy values specified by a context to resolve the information.

### RELATED APPLICATIONS

The present disclosure claims priority from U.S. Provisional Application No. 61/097,038, filed Sep. 15, 2008, the entire contents of which are incorporated herein by reference.

### FIELD OF THE DISCLOSURE

The present disclosure relates to the resolution of determinate and consistent information on behalf of info-consumers, and in particular to the resolution of determinate and consistent information on behalf of info-consumers in a context aware mobile network.

### BACKGROUND

Applications possess functional utilities that have important characteristics known as context. Context is defined as “the set of information which surrounds, and gives meaning to something else”. Examples of context can be found, for example, in presence applications, location applications, among others.

With regard to presence information, presence metadata provides meaning and the presence information is the basis of the context. The meaning is applied to or part of a particular function or a particular feature of a function within an application to establish an appropriate set of processing steps.

In one example, an instant message (IM) client application operable on a first user's mobile device may require functionality to establish whether other individuals or peers are reachable to permit the first user to initiate an IM chat session. It is also possible that within an IM client, functionalities are required to establish a peer user status icon to represent a second user. In the first scenario, context relates to whether the second user is reachable to initiate a chat. In the second scenario, it is important for the first user's IM client to discriminate and derive a status icon based on the second user's status and availability to display the correct avatar. In the context of the IM client, reachability as it relates to peer status icon feature is not relevant whereas it is completely relevant for the initiated chat function.

The above demonstrates, in a presence environment, that context plays a significant role in how an individual's presence information may be computed to derive presence related aspects, including reachability, availability, among others. As will be appreciated, context also applies in other scenarios besides presence.

A presence service captures presence information from one or more presence sources. Once this data is collected, a presence service composes the captured metadata and distributes a raw presence metadata document to authorized watchers. The OMA-Presence service platform is a demonstrative example of a presence service. The OMA-Presence enabler outlines, in very detailed written form, semantics and policy related to the publication and consumption of presence information.

### BRIEF DESCRIPTION OF THE DRAWINGS

The present disclosure will be better understood with reference to drawings in which:

FIG. 1 is a block diagram showing an exemplary traditional presence platform with a push to talk over cellular client and server;

FIG. 2 is a flow diagram illustrating a processing method on a client device for deriving reachability aspects;

FIG. 3 is a block diagram showing an exemplary presence system in which a presence context aware mechanism has been added;

FIG. 4 is a block diagram showing an exemplary presence system in which a presence context aware mechanism has been added and distributed between a server and agents;

FIG. 5 is a block diagram showing an exemplary presence system in which a presence context aware mechanism has been added to a PoC server;

FIG. 6 is a block diagram showing an exemplary presence system in which a presence context aware mechanism has been added to a Presence Platform;

FIG. 7 is a block diagram showing an exemplary location system in which a location context aware mechanism has been added;

FIG. 8 is a block diagram showing an exemplary generic system in which a generic context aware mechanism has been added;

FIG. 9 is a flow diagram showing a method to determine reachability when utilizing a P/CAM;

FIG. 10 is a flow diagram showing a method to determine whether a prospect is eligible to receive advertisements utilizing a P/CAM;

FIG. 11 is a flow diagram showing a method to determine whether a push client can have content pushed to it utilizing a P/CAM;

FIG. 12 is a call flow diagram showing call flow for policy setup;

FIG. 13 is a call flow diagram showing call flow for aspects within an OMA/PRS environment;

FIG. 14 is a call flow diagram showing call flow for aspect triggers; and

FIG. 15 is a flow diagram showing a method for resolving indeterminate states.

### DETAILED DESCRIPTION

### Terms

In the present description the following terms are used as follows:
Context That which surrounds, and gives meaning to something else.
OMA Open Mobile Alliance
PEEM Policy Evaluation, Enforcement, and Management Enabler
Presence Info A basic unit of presence (e.g. activity or mood is presence info).
Presence Service Entity or platform that receives presence info from presence sources.
Presence Source Entity that relates presence info on behalf of 1+ presentities.
Presentity Entity that has presence information related to it.
Watcher Entity that wishes to consume presence info.
Context Aware Layer A Layer that may be an access, application abstraction or proxy layer. This layer that can make use of aspects. The layer could be deployed over a network. The layer is adapted to handle requests from a plurality of clients of various types. Includes context aware mechanisms, including an x/CAM, which is a generic (non-specific) context aware mechanism, as well as more specific mechanisms such as presence (p/CAM) and location (L/CAM).

### DESCRIPTION

The present disclosure provides a method for resolution of indeterminate or inconsistent information on behalf of an information consumer, the method comprising: using a processor of a middleware component to determine whether information for the information consumer is resolvable; and if the information is determined to be unresolvable, utilizing at least one of rules, policy types and policy values specified by a context to resolve the information.

The present disclosure further provides a middleware component configured to resolve indeterminate or inconsistent information for an information consumer, comprising: a processor configured to: determine whether information for the information consumer is resolvable; and if the information is determined to be unresolvable, utilize at least one of rules, policy types and policy values specified by a context to resolve the information.

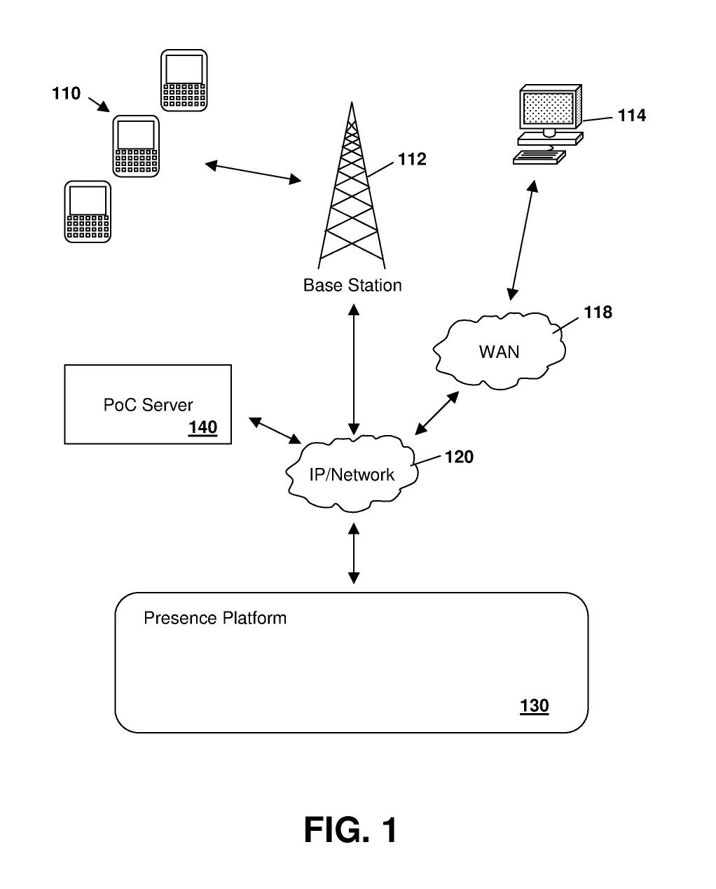

FIG. 1 illustrates a block diagram of a traditional presence platform with a push to talk over cellular (PoC) client. The use of a presence platform is merely an example, and other platforms such as a location or generic information providing platform (e.g. a content delivery or mobile advertising information providing platform) are possible. Specifically, in FIG. 1, user devices 110 communicate over a cellular system with a base station 112, which then communicates with an Internet Protocol network 120 or other network as known to those skilled in the art. As will be appreciated, base station 112 could be a base station for any known cellular service. Further, devices 110 could communicate with a network 120 throughout other means such as a short/long range wireless communication like Bluetooth™, over WiFi/WiMax or WLAN, through a wired connection such as through a USB or Serial port and through a computer modem. Other means of connecting to network 120 would be known to those skilled in the art.

In the system of FIG. 1, a desktop 114 with a PoC client can further communicate through a wide area network 118 to network 120.

A presence platform 130 receives and sends out presence information flow from network 120 to user devices 110 or desktop 114. Presence platform 130 is adapted to store raw data regarding states of clients and to update client records when new state data is received. Presence platform 130 is further adapted to provide or distribute presence information to watchers or interested observers when required. Thus presence information flows both to and from presence platform 130.

A push talk over cellular (PoC) server 140 further exists within the system of FIG. 1 and in one embodiment could publish state information on behalf of a presentity or a watcher. As will be appreciated by those skilled in the art with reference to FIG. 1, the consumption and interpretation of presence metadata to achieve functions or features within the context of an application relating to a subject of interest is entirely the responsibility of the application. An application in this case could be the PoC server, a PoC client or an IM client, among others.

User device 110, desktop 114 and PoC Server 140 could act as both watchers and presence sources in the example of FIG. 1.

As will be further appreciated by those skilled in the art, the requirement for the consumption and interpretation of presence metadata to achieve functions or features within the context of an application increases the complexity of a client application and this has the net effect of increasing the associated memory footprint as well as the overall processing, power consumption and network bandwidth requirements for the application. In addition, a presence related application further becomes susceptible to changes or additions to the underlying presence metadata or changes to presence platform semantics or policy. For example, a bug fix or a change to OMA presence related standards could require a client application to be updated or changed in order to correctly interpret presence metadata in the future. Also, metadata or presence semantics could be added, and/or changed which could impact the client application.

The above has the net effect of frequent changes to the application deployed within a user's execution environment in order to properly maintain an appropriate watcher and/or presentity view. There is also a further time cost and cost related to the re-deployment of a given updated client application.

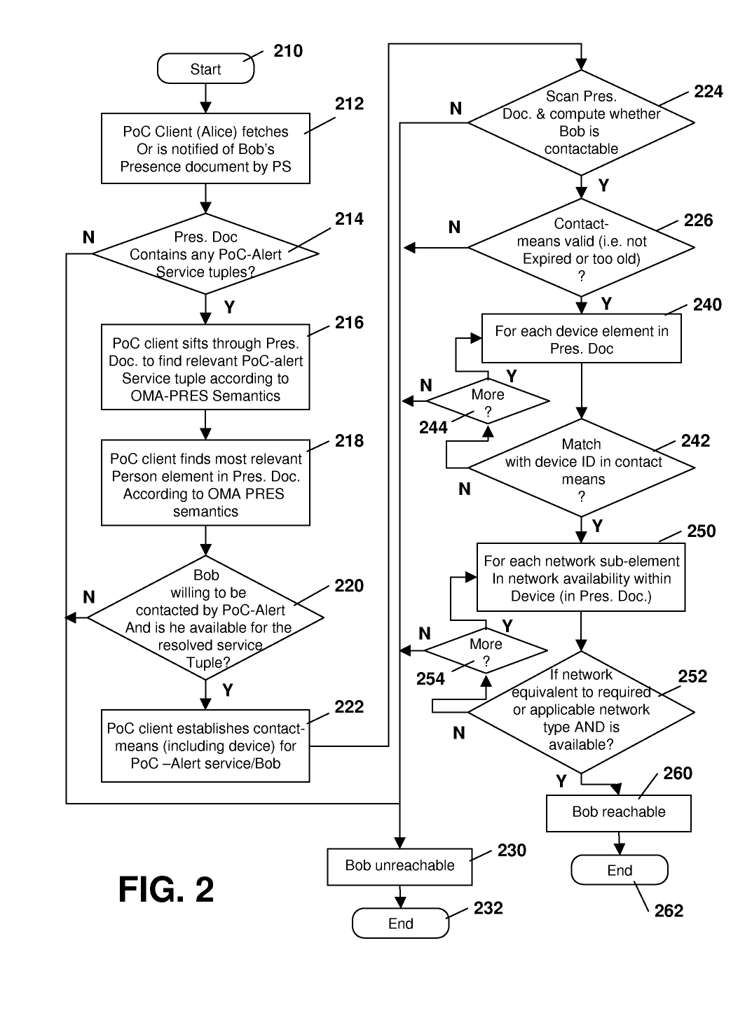

This is further illustrated with reference to the example of FIG. 2. Reference is now made to FIG. 2, which shows a flow chart of a simple transaction in which a PoC client application is to initiate a PoC-alert to a subject of interest. In this case, a first user Alice wishes to send a PoC alert to presentity Bob using her PoC client (a watcher).

The process starts at block 210 and proceeds to block 212 in which the PoC client fetches or is notified of Bob's presence document by a presence server. As will be appreciated by those skilled in the art, when service is implemented for Bob and Alice to be able to push-to-talk to each other, either a subscription is made with the presence server to provide a presence document related to Bob, or when the PoC wishes to communicate with Bob then a fetch is done from the presence server and this information is received as a presence document in block 212.

The process then proceeds to block 214 in which a check is made to see whether the presence document contains any PoC alert service tuples. As will be appreciated, this is a check to see whether or not anything in the presence document is related to the service identifier that is required for this service (in this case the PoC alert service).

If, in block 214, the presence document does contain PoC-alert service tuples the process proceeds to block 216 in which the PoC client sifts through the presence document to find relevant PoC-alert service tuples according to specified OMA presence semantics. As will be appreciated, this provides a way to distill out relevant information for the service being requested. The client in this case needs embedded knowledge of the OMA presence semantics in order to carry out this processing step.

The process then proceeds to block 218 in which the PoC client finds the most relevant person element in the presence document according to specified OMA presence semantics. As will be appreciated, there could include multiple person elements. OMA/Presence defines semantics for determining the most relevant person.

The process, in block 220, next checks to see whether Bob is willing to be contacted by PoC-alert and if he is available for the resolved service tuple. As will be appreciated, the terms “willing” and “available” are specific to presence and have predefined criteria for resolving whether or not someone is “willing” and/or “available”.

If Bob is “willing” and “available” the process proceeds to block 222 in which the PoC client establishes contact means including the device for the PoC alert service for Bob. As will be appreciated, multiple addresses corresponding to a presentity (or entity of interest) could be provided and priority for those addresses could also be provided.

The process then proceeds to block 224 in which a check is made to see whether Bob is “contactable”. Again this has a specific meaning within the presence semantics and indicates that if Bob is “willing” and “available” then a contact means needs to be established.

The process then proceeds to block 226 if Bob is “contactable”. At block 226 a check is made to see whether the contact means is valid. The contact means may be invalid if it is expired or if it is too old and a time limit on the validity of the context means has been placed, among others.

From blocks 214, 220, 224, or 226 if a negative conclusion is reached the process proceeds to block 230, which indicates that Bob is unreachable, and the process ends at block 232.

From block 226, if the contact means is valid the process proceeds to block 240 in which each device element in the presence document is identified. For each presence document the process proceeds to block 242 in which the device identifier is matched with the contact means. If a match is made the process proceeds to block 250. Otherwise the process proceeds to block 244 in which a check is made to see whether there are more device elements available. If yes, the process proceeds back through block 240 and 242. Otherwise, the process proceeds to block 230 in which Bob is deemed unreachable and the process ends at block 232.

At block 250, the process isolates each network's sub-element in network availability with a device or devices matched in processing step 242 and a check is made at block 252 to see if the network is equivalent to the required or applicable network type for the PoC alert service, and that the network is available. If the process of block 252 receives a positive result, the process proceeds to block 260 in which Bob is deemed reachable and the process then ends at block 262. Based on applicable OMA semantics, block 260 may also incorporate or otherwise indicate applicable device(s) applicable to the reachable presentity (Bob).

Otherwise, the process proceeds to block 254 in which a check is made to see if there are other network sub-elements that can be utilized and if yes the process proceeds through blocks 250 and 252 again to make the check to see whether or not the network is equivalent to the required or applicable network type and is available. From block 254, if no other network subtypes are available the proceeds to block 230 in which Bob is deemed unreachable and process ends at 232.

Having regard to FIGS. 1 and 2 above, the contextual interpretation of presence information is embedded within each client application. Each client application can receive a different or the same set of presence metadata and in situations where multiple applications share the same raw presence metadata, the fact that the contextual interpretation is individually tied to each of them increases the possibility that two different client applications will arrive at differing conclusions about a specific presence aspect. This may not provide the desired outcome and may lead to interoperability issues, particularly between client applications that must share or treat specific presence aspects in an orthogonal and consistent manner.

For example, an email and an IM client that both derive a person's reachability from the same raw presence metadata may come to different conclusions as to whether someone is reachable based on subtle variations in each client application's presence processing steps. This may result in the email client concluding that the person is reachable while the IM client determines that the individual is unreachable. In addition to a bad quality of service and a poor user experience, this inconclusiveness could result in issues with interoperability such as not being able to spawn an IM chat session from an email client when reviewing an individual's email due to a state mismatch error.

Abstracting raw presence information into a dedicated context aware layer which supports “presence aspects” based on contextual rules and policies allows for the possibility of applications to work collaboratively to achieve derived functionality and to carry out intelligent workflows as a result of a compound context presence. Context for presence provides a view or perspective of presence given the surrounding environment. The surrounding environment may include a service, or the consumer requesting presence information, etc. For example, a project manager wishes to host a project status meeting. The manager establishes a meeting invitation (from an enterprise email/calendaring application) on her desktop execution environment to meeting participants. A presence-context platform working on behalf of the mail/calendaring application may be able to support the following types of functions as a result of the user initiating the invite:
Determine an appropriate time based on participant availability;
Based on contextual policy, book an appropriate meeting room for the meeting (context may include choosing a suitable building, with the correct A/V environment, that is close to meeting participants);
Determine based on participant location (and enterprise policy) whether a conference bridge must be booked (and reflect this to appropriate individuals in the meeting request);
Based on hints or policy given by the meeting moderator through the application, invite relevant participants who fulfill a given criteria (e.g. a member of the marketing team, a member of the development team, a member of the quality assurance (QA) team, an individual with a specific skill or knowledge, etc.).

Further, various application servers can integrate the presence context aware mechanism (P/CAM) to gain efficiency by reducing the number of communication and processing steps. For example, a mobile advertisement server could integrate with a P/CAM to simplify and streamline its presence aspects to focus on core functionality such as the delivery of contextually relevant mobile advertisements.

The present disclosure provides for a method and system for establishing a context where a mechanism is connected in series with a server platform to support a given application. Context awareness resides in whole or in part within the network and provides a composite view or perspective of presence/location or other related information/metadata aspects to an application or multiple applications on behalf of various entities such as a given presentity and/or watcher in the presence case. For each case, this is achieved by associating rules, triggers, and policies against presence related aspects such as availability, contactability, reachability, state, among others, into a context aware layer. Rules or triggers may be extended or overridden to provide additional or application specific behavior to different classes of applications or enablers.

Context awareness may be replicated to a presence or location context aware mechanism connected in series with a presence or location service platform to provide a client application or a service with location related aspects. A location context aware mechanism (L/CAM) makes use of location information provided by a location enabler service, location information stored in a presence service or other location information store. For example, the location could be derived using base or extended cell tower information.

Location specific rules and policies are associated against location related aspects such as within a geographical area, who is close by, am I there yet, among others, into a location context aware layer. As with a P/CAM, rules or triggers may be extended or overridden to provide additional/application and/or environment specific behavior to different classes of applications or service enablers.

Similarly, a “generic” context aware layer (context aware mechanism) could contain a combination of a P/CAM, L/CAM and specific application context aware mechanism. An example could be a mobile advertising platform where presence, location and campaign related information are used in combination to target advertisements of interest towards a user. Other generic platforms could include a network address book service, a network community service, among others.

As will be appreciated by those skilled in the art, a context aware mechanism is applicable to both a wired and wireless execution environment and computing domain. This approach has several benefits including a dramatic reduction in the complexity of an associated application running within a user's execution environment. A contextually aware platform located on the network permits a given client application or enabler to focus on its core competency such as chat within a IM client, visualizing a person's location in a location client, among others. Functionality is achieved by establishing and injecting at execution time the applicable policies and by invoking specific rules and/or triggers relevant to the context of the client application, environment or the enabler to provide utility on behalf of the user.

In a further embodiment, a context aware platform or context aware layer includes both an x/CAM server and an x/CAM client or agent that work in concert. Further, in some embodiments of the x/CAM, the same distributed or non-distributed aspects as the P/CAM and L/CAM above are possible. For instance, the context aware layer may exist only server side in some embodiments. The context aware layer client or agent is embedded within an execution environment. The interface to a context aware platform is web-centric. Examples include extensible markup language (XML) web services such as simple object access protocol (SOAP), representational state transfer (REST) or XML over hypertext transfer protocol (HTTP). The above supports a context aware layer deployment scenario whereby an application or enabler could directly interact or manipulate the context aware mechanism to more closely model the appropriate behavior. For example, a mobile advertising server co-located with a P/CAM agent could be used to override presence policies to better align presence with the underlying functionality of the platform. For example a mobile advertising server can integrate or make use of an x/CAM ‘layer’. Such x/CAM could be a superset of a P/CAM, UCAM and specific advertisement/CAM.

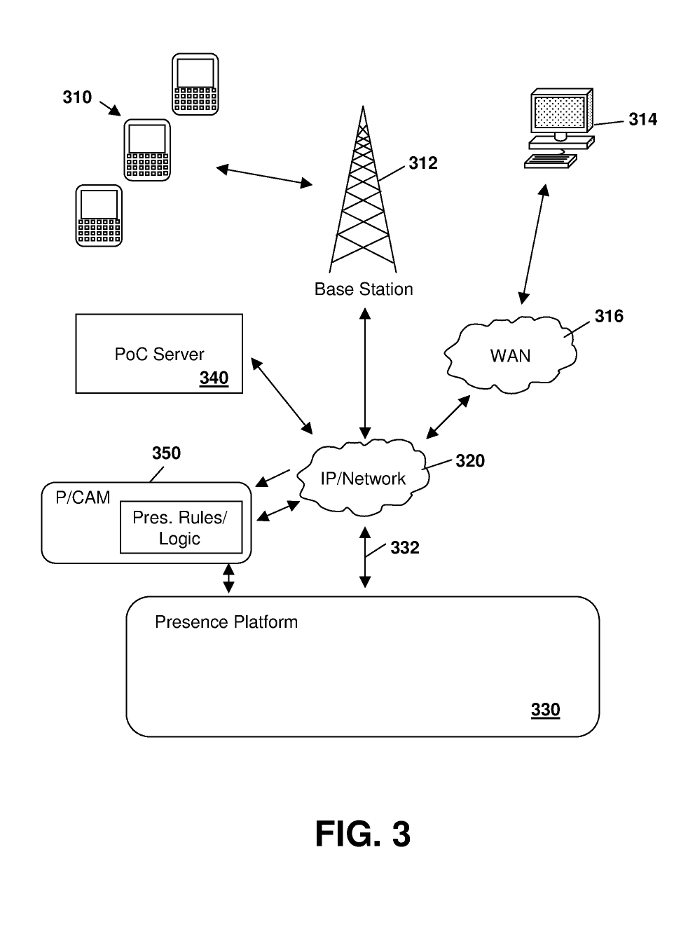

Reference is now made to FIG. 3. FIG. 3 illustrates a system diagram for a presence platform with a PoC client application utilizing a P/CAM as the context aware layer. As will be appreciated, FIG. 3 utilizes similar network aspects to those of FIG. 1 with the addition of the P/CAM.

In FIG. 3, user devices 310 communicate through a base station 312 to a network 320. Further, a desktop 314 communicates through a wide area network 316 with network 320.

A presence platform 330 is adapted to store raw data and state updates that have been received from clients.

Further, a PoC server 340 exists and is adapted to publish or consume state information on behalf of or in conjunction with users.

A presence context aware mechanism server 350 provides the context aware layer and communicates with network 320 and receives policies, dynamic rules and/or triggers from clients over network 320 and further publishes and receives presence aspects through network 320.

A presence context aware mechanism server 350 further communicates with presence platform 330 to provide and receive presence information flow.

FIG. 3 further illustrates a link 332 between network 320 and presence platform 330. As will be appreciated, this link is left in order to allow clients who want to communicate directly with the present platform the ability to do so or to provide for communications with the platform for new information or advanced information that the P/CAM server 350 may not yet be aware of.

Based on the above, P/CAM server 350 receives policies, rules and triggers and is adapted to provide and receive presence aspects based on these rules and logic to clients such as devices 310 or desktop 314, or PoC server 340.

As will be appreciated, in other embodiments, various aspects or functionality of the P/CAM can be distributed throughout the network and in some instances the entire P/CAM can be placed onto other devices or clients within the network.

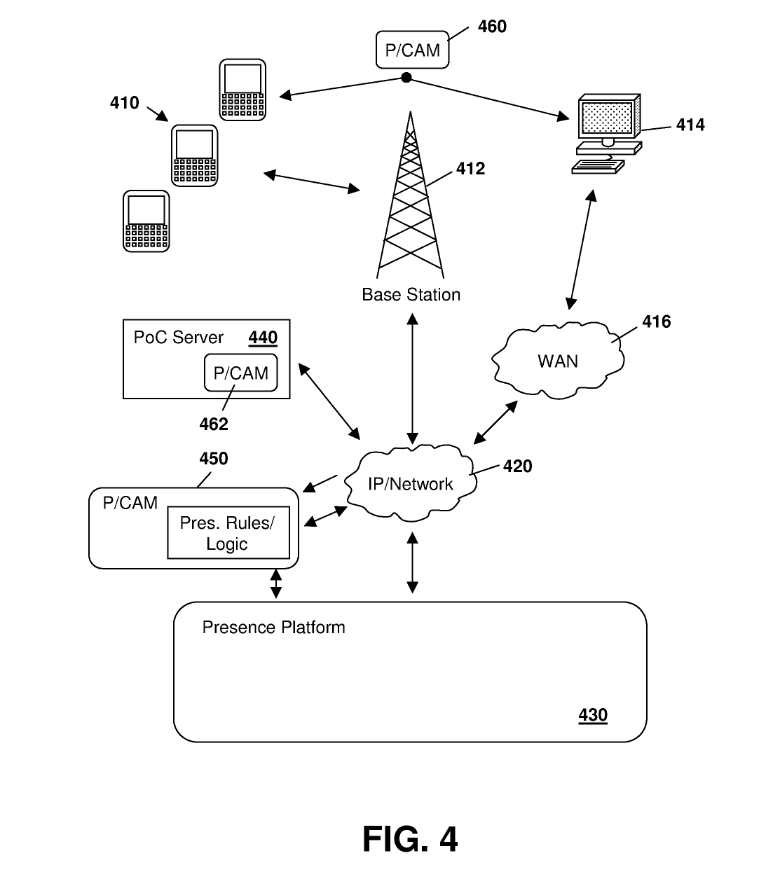

Reference is now made to FIG. 4. FIG. 4 shows a system similar to that of FIGS. 1 and 3 in which the P/CAM functionality has been distributed through P/CAM agents on various devices.

Specifically, user devices 410 communicate through a base station 412 with network 420. Further, a desktop 414 communicates over a wide area network 416 with network 420.

A presence platform 430 is adapted to store raw data and state updates that are received from clients.

Further, a PoC server 440 is adapted to communicate with network 420 and publish or consume state on behalf of or in conjunction with client applications.

A P/CAM server 450 as the context aware layer is adapted to communicate with network 420 and to receive policy, rules and thresholds and provide and receive presence aspects to and from clients such as user devices 410 and desktop 414 through P/CAM agent 460 or PoC server 440 through P/CAM agent 462.

P/CAM 450 is further adapted to communicate with presence platform 430 to receive and send presence information flow.

In the embodiment of FIG. 4, some of the functionality of P/CAM server 450 is, however, distributed in order to allow the full functionality of the P/CAM, or part of it, to be performed on the device 410, desktop 414 or PoC server 440, for example. This is illustrated by P/CAM agent 460 on user devices 410 or desktop 414 and P/CAM agent 462 on PoC server 440. In this case, the context aware layer comprises both P/CAM server 450 and P/CAM agent 460 and/or 462.

P/CAM agent 460 or 462 could contain rules and/or policies that are predefined. Further, the P/CAM agent 460 or 462 can be used to manipulate presence information or interoperate with metadata or clients on the host execution environment in some embodiments.

As will be appreciated, in some embodiments the entire P/CAM can be located on a client or other server.

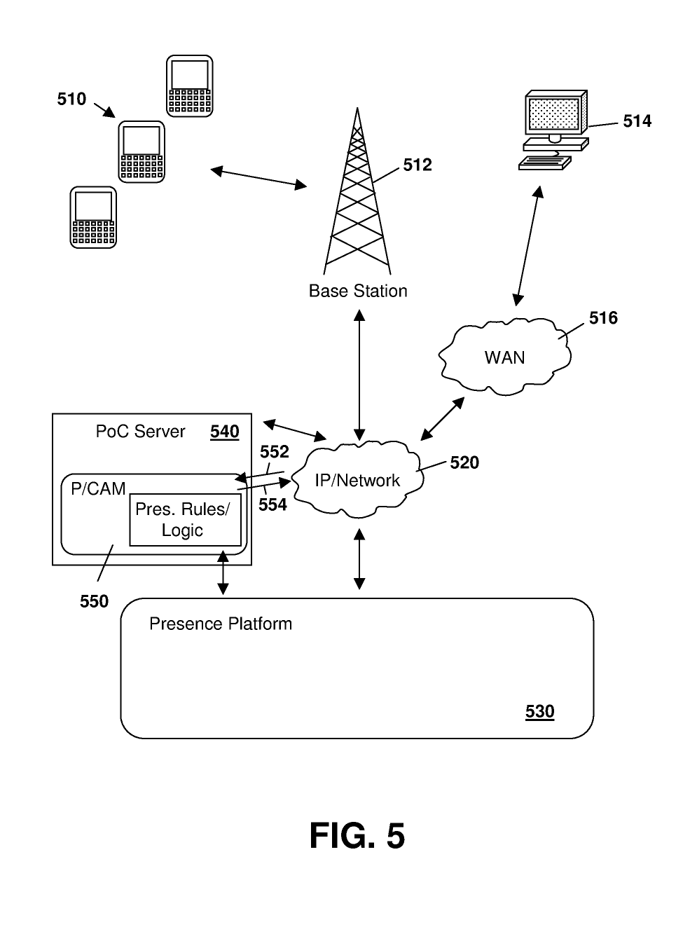

Reference is now made to FIG. 5. FIG. 5 illustrates a system diagram in which the P/CAM server (context aware layer) is embedded within the PoC server.

Specifically, in FIG. 5, user devices 510 communicate through base station 512 with a network 520. Further, desktop 514 communicates over a wide area network 516 and to network 520.

A presence platform 530 is adapted to store raw data and updates received from clients regarding presence.

A PoC server 540 is adapted to communicate with network 520 and to publish or consume state on behalf of or in conjunction with clients.

PoC server 540 further includes P/CAM 550 embedded therein. P/CAM 550 communicates with presence platform 530 to exchange presence information flow and further communicates over network 520 to receive policy information, rules and thresholds and to further receive and publish presence aspects. Specifically, communications 552 provide P/CAM 550 with policy and dynamic overloaded rules and communications 554 provide network 520 with presence aspects. This includes actions as a result of a detected presence aspect change, such as a notification issued via communications 554 to be transmitted over network 520.

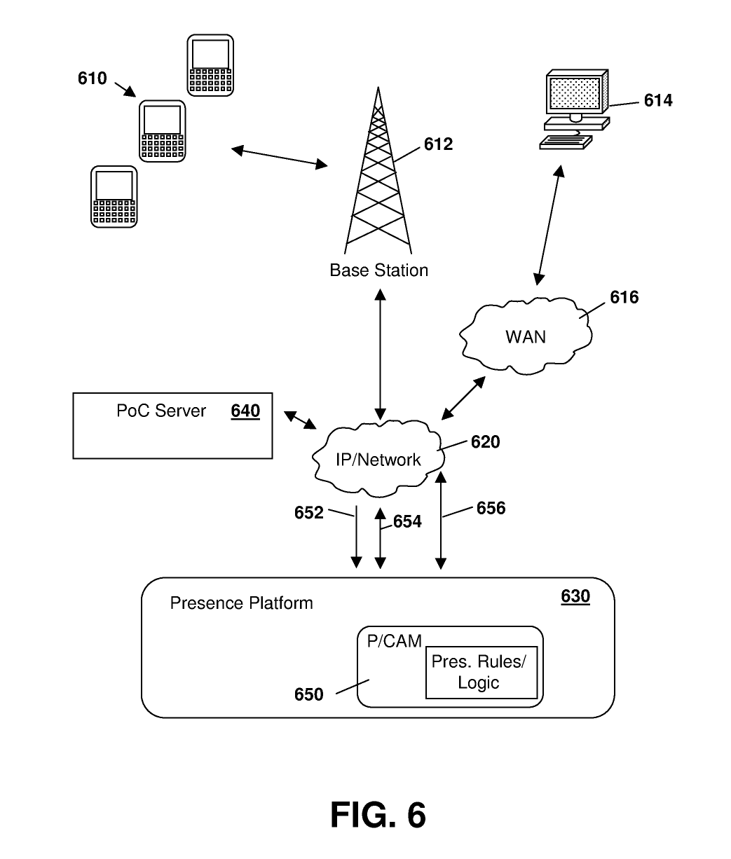

Further, an implementation could be defined as a P/CAM layer integrated within a service enabler, e.g.: as part of the Presence Platform itself. The latter implementation, as illustrated in FIG. 6, could also support a variation whereby a P/CAM client/agent (context aware layer) resides on the mobile device and/or as part of an associated enabler (e.g. a MobAd server).

Reference is now made to FIG. 6. FIG. 6 illustrates a system diagram in which the P/CAM server is embedded within the presence platform 630.

Specifically, in FIG. 6, user devices 610 communicate through base station 612 with a network 620. Further, desktop 614 communicates over a wide area network 616 with network 620.

A presence platform 630 is adapted to store raw data and updates received from clients regarding presence.

A PoC server 640 is adapted to communicate with network 620 and to publish or consume state on behalf of or in conjunction with clients.

Presence platform 630 further includes P/CAM 650 embedded therein. P/CAM 650 communicates internally with presence platform 630 to exchange presence information flow and further communicates over network 620 to receive policy information, rules and thresholds and to further receive and publish presence aspects. Communication 652 shows policy/dynamic overloaded rules being received from network 620. Communication 654 shows presence aspects being sent and received between presence platform 630 and network 620. This includes actions as a result of a detected presence aspect change. For example, a notification issued via communications 654 to be transmitted over network 620. Communication 656 shows presence information flow between presence platform 630 and network 620.

As will be appreciated with reference to FIGS. 3, 4, 5 and 6 above, context awareness reduces network latency by reducing the amount of data transmitted between a user's execution environment and a presence platform. This is especially important in a wireless domain where CPU usage, battery consumption and network bandwidth are precious resources. Further, given a context abstracts the specific details of a presence platform, a client application or enabler is less brittle and significantly more resistant to underlying changes in the model or semantics of the presence platform.

As will be appreciated, FIGS. 3, 4, 5 and 6 above are provided with reference to a P/CAM. However, the above could equally be applicable with a location platform and a L/CAM or a generic platform and an x/CAM. Further, a combination of these is possible. The P/CAM, L/CAM, X/CAM or combination form the context aware layer.

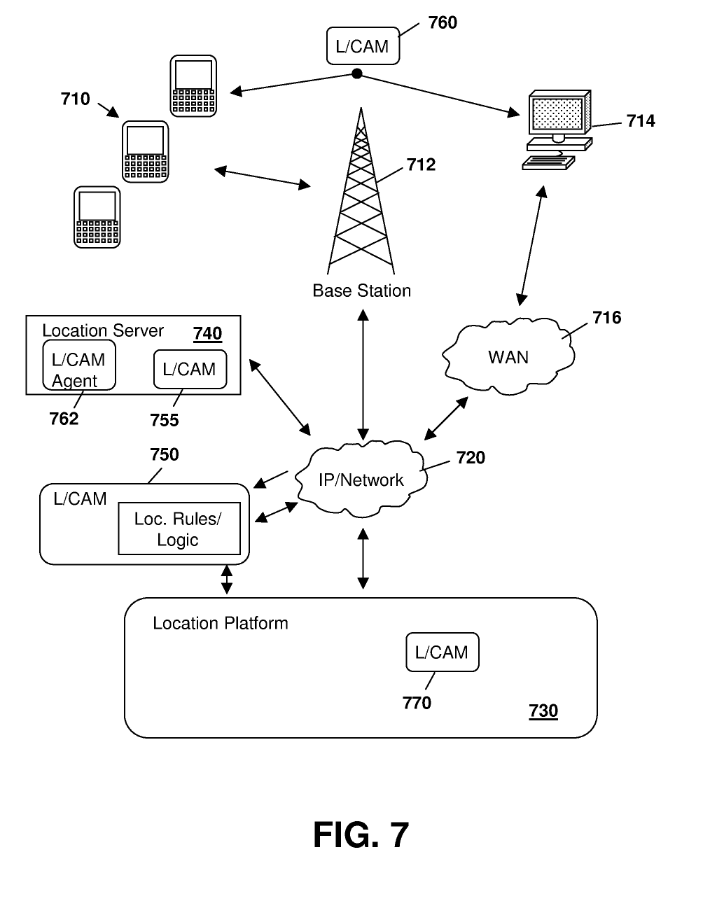

With reference to FIG. 7, user devices 710 communicate through a base station 712 with a network 720. Further, a desktop 714 can communicate through a wide area network 716 with network 720. A location platform 730 is adapted to provide and store raw data regarding the location of user devices 710 and further to receive updates from user devices 710 and store this information.

A location server 740 is further adapted to communicate with a network 720 and can provide or assist with the location of various clients.

An L/CAM 750 could be a stand alone server communicating with a network 720 and with location platform 730. In an alternative embodiment the L/CAM server can be co-located on the location server as illustrated by reference numeral 755. In further embodiments, L/CAM agents can be located on devices such as agent 760 on user devices 710 or on the location server such as agent 762. In the case that agents 760 and 762 are used, various functionalities or all of the functionality of the UCAM can be distributed to the user devices or the location server.

In further embodiments, the L/CAM can be part of the location platform 730, as shown by L/CAM 770.

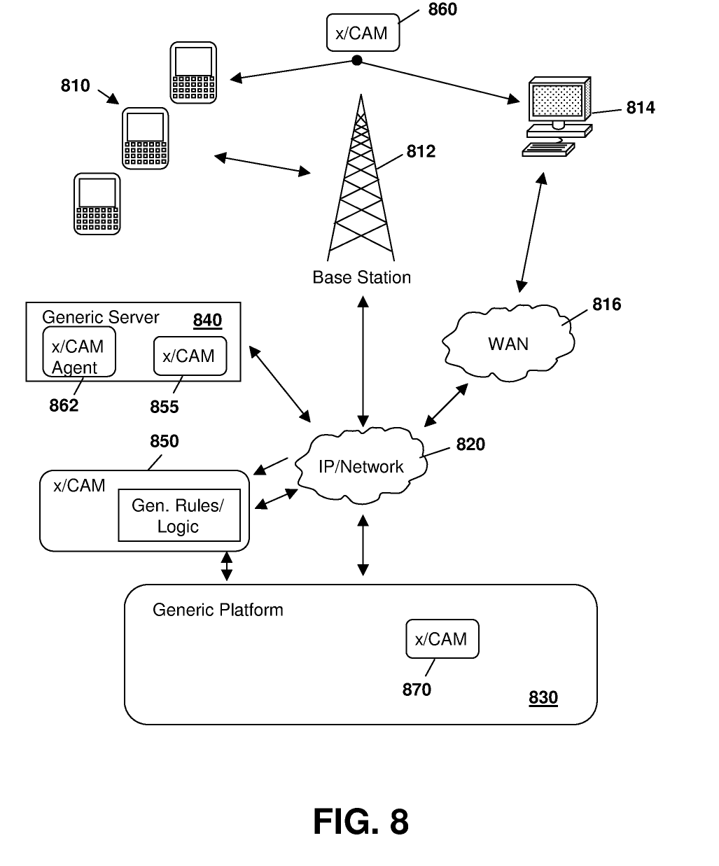

Referring to FIG. 8, a generic environment is provided. In FIG. 8, user devices 810 communicate through a base station 812 with a network 820. Further, a desktop 814 communicates through a wide area network 816 with network 820. Also, a generic platform 830 is adapted to store data and states for various devices. Other servers such as a generic server 840 can exist within the network and can communicate over network 820.

Further, a generic x/CAM 850 is adapted to communicate with network 820 and with generic platform 830. In other embodiments, the x/CAM can be located on generic server 840 and this shown as x/CAM 855.

In yet further embodiments, the x/CAM can have agents 860 or 862 that are located on user devices 810 or on generic server 840 respectively.

In further embodiments, the x/CAM can be part of the generic platform 830, as shown by x/CAM 870.

The above therefore illustrates how a platform, whether it be presence, location, generic or a combination of the previous may be abstracted to a context aware layer using context aware mechanisms or layers to support a multiplicity of application types or enablers.

The above is implemented utilizing policies and rules/triggers. A process relating to this mechanism is provided below.

In accordance with one embodiment of the present disclosure, a context or mechanism, whether it is presence, location or generic, consists of policies, aspects, and rules and/or triggers. Each is described in detail below. The description below has been presented with reference to a presence context or mechanism. This is, however, not meant to be limiting and those skilled in the art would appreciate that the below could be equally applicable to location or generic context or mechanisms.

### Policy:

Policy is associated with a particular presence context at an appropriate point in the application life cycle, to specify the behavior or treatment of presence, location or generic related aspects. Policies augment rules/logic flows in terms of how they operate, to provide a more accurate and meaningful computation of aspects on behalf of a client application or enabler. As will be appreciated, a policy can apply to a class of applications, an individual application or even to a user and can be provisioned with settings on how aspects are computed.

Policy may be expressed using the Open Mobile Alliance's (OMA) policy evaluation, enforcement and management (PEEM)/policy expression language (PEL). PEL defines a generic and extensible grammar in which policies may be expressed using a rule set language. PEL is based on Internet Engineering Task Force (IETF) request for comments (rfc) 4745. Conditions and/or actions (as specified in rfc 4745) may be enhanced within the scope of PEEM, through the OMA XDM (XML Document Management) common policy extensions, as detailed in OMA-SUP-XSD_XSD_xdm_extensions-V1_0. The policy can also be expressed on IETF rfc 4745.

As will be appreciated, PEEM is a continuing standards effort by the OMA to define common functions needed by its enablers.

As an example, the following table describes relevant presence policies for use by a presence context in the computation of presence aspects. These policies have applicability to the OMA presence platform. However, given policies may be added or removed from the given context as required and the concept is applicable to a multiplicity of presence platforms. In the table below, the default value, if applicable, is shown in italics.

TABLE 1
Presence Policies

| Policy | Description | Values |
|---|---|---|
| opt-in-source | Indicate which pres. element is | willing \| |
| | an indicator of service opt-in. | ignore |
| | Default value indicates opt-in not | |
| | relevant for the given comm. | |
| | service. | |
| applicable-network- | Indicate the applicable network | IMS, SIP, <token>, . . . |
| type | type(s) for the given comm. | |
| | service. | |
| threshold-value- | Establish an equality comparison | <label> <qn-elem> <value> |
| equals | operation threshold named label, | |
| | with qn-elem, and value. A | |
| | boolean value of ‘true’ or ‘1’ or | |
| | ‘yes’ would apply if the policy | |
| | was applied to the xml-ns and | |
| | the resulting target matched | |
| | value. | |
| threshold-value-less- | Identical to equality, with the | <label> <qn-elem> <value> |
| than | exception that the comparison | |
| | operator is less than (<). | |
| threshold-value- | Identical to equality, with the | <label> <qn-elem> <value> |
| greater-than | exception that the comparison | |
| | operator is greater than (>). | |
| unavailable-activies- | Indicate the subset of activities | busy, holiday, meal, in-transit, |
| set | from the watcher perspective that | permanent-absence, sleeping, |
| | would render a contact | unknown, worship |
| | unavailable. This set may be | |
| | defined as empty which is an | |
| | indication that activities has no | |
| | bearing on availability. | |
| undef-servcaps-sub- | Indicate how to interpret the | unknown \| unsupported |
| elements | absence or omission of specific | |
| | <servcaps> sub-elements in | |
| | presence metadata. | |
| undef-barring-state | Indicate how to interpret the | ignore \| active \| terminated |
| | absence or omission of <barring- | |
| | state> sub-elements in presence | |
| | metadata. | |
| undef-registration- | Indicate how to interpret the | ignore \| active \| terminated |
| state | absence or omission of | |
| | <registration-state> sub-element | |
| | in presence metadata. | |
| undef-willingness | Indicate how to interpret the | (open,indefinite) \| (closed,indefinite) |
| | absence or omission of | \| (open,time-ofs-value) \| (closed,time- |
| | <willingness> for the given | ofs-value) |
| | comm. service. | |

Table 1 above defines various policies and values for the policies. As indicated in the table, various policies exist and the description of the policy and the values are provided.

In the first row of the table, a first policy is “opt-in-source”. The policy is used to indicate which presence element is an indicator of service opt-in. The default value indicates that opt-in is not relevant for the given communication service.

The values that are possible for the opt-in-source policy are willing, or ignore. As will be appreciated, these could be selected by various entities such as the service provider, among others. The entity choosing the policy can choose which values to utilize. Thus, for example, the service provider could choose to ignore opt-in source for the first policy.

The second policy described in Table 1 is applicable-network-type and indicates the applicable network types for a given communication service. A default, as shown, is IMS. However, other values include session initiation protocol (SIP) or a token and can be chosen by the selecting entity.

The third policy is “threshold-value-equals” and could be utilized to establish an equality comparison operation threshold named label with a qualified name XML element and value. A boolean value of one or true or yes would apply if the policy was applied in the XML name space and the resulting target matched the value.

The next policy in Table 1 is “threshold-value-less-than”. This is the same as threshold-value-equals except that it utilizes the less-than comparator.

Similarly, the next policy is “threshold-value-greater-than” which is the same as the above, except with the greater-than operator.

The next policy is “unavailable-activities-set” and could include a subset of activities that would render the contact unavailable in the context of the application, service or enabler. In the default setting this is unknown, but it could include things like busy, holiday, meal, among others.

The next policy is “undef-servcaps-sub-elements” and indicates undefined service capabilities and how the application is to interpret these. For example, Table 1 indicates that if the service capability is undefined it could be considered to be unsupported.

The next policy in Table 1 is “un-def-barring-state” and indicates how to interpret the absence or omission of a barring-state XML element in presence metadata and could include that the state is active or terminated. The default is that the state will be ignored.

Similarly, an “undef-registration-state” indicates how to interpret the absence or omission of a registration-state XML element and is by default ignored but could also be active and terminated in the example of Table 1 above.

The final policy defined in Table 1 above is “undef-willingness” and indicates how to interpret the absence or omission of a willingness XML element for a given communications service and could include a pair consisting of a state (open, or closed) along with a validity period (either an indefinite period or a preset validity period).

As will be appreciated by those skilled in the art, Table 1 above is merely meant as an example and other policies are possible based on the needs of a system or user.

To support the policies in the preceding table, the P/CAM requires additional XML types and element definitions in order to extend the PEL common-policy “actions”. The following XML schema document provides further details relating to how these actions may be extended for use by a P/CAM.

<?xml version=“1.0” encoding=“UTF-8”?>
<xs:schema

```
  targetNamespace=“urn:oma:xml:xdm:extensions:cam”
  xmlns=“urn:oma:xml:xdm:extensions:cam”
  xmlns:xs=“http://www.w3.org/2001/XMLSchema”
  elementFormDefault=“qualified” attributeFormDefault=“unqualified”>
<!-- This import brings in the XML language attribute xml:lang -->
<xs:import namespace=“http://www.w3.org/XML/1998/namespace”
  schemaLocation=“http://www.w3.org/2001/xml.xsd”/>
  <!—- P/CAM specific “actions” child element extensions to -->
  <!—- namespace urn:ietf:params:xml:ns:common-policy -->
<xs:element name=“opt-in-source” type=“OptInSourceType”/>
<xs:element name=“applicable-network-type” type=“ApplicableNetworkType”/>
<xs:element name=“threshold-value-equals” type=“ThresholdEqType”/>
<xs:element name=“threshold-value-less-than” type=“ThresholdLtType”/>
<xs:element name=“threshold-value-greater-than” type=“ThresholdGtType”/>
<xs:element name=“unavailable-activities-set” type=“UnavailActivityType”/>
  <xs:element name=“undef-servcaps-sub-elements”
```

type=“UndefServCapsSubElemsType”/>

<xs:element name=“undef-barring-state” type=“UndefBarringStateType”/>
<xs:element name=“undef-registration-state”

type=“UndefRegistrationStateType”/>

<xs:element name=“undef-willingness” type=“UndefWillingnessType”/>
<!-- Type definitions defined by this document-->
<!-- OptInSource indicator -->
<xs:simpleType name=“OptInSourceType”>

<xs:annotation>

<xs:documentation>
Policy: opt-in-source
The associated service(s) use ‘willing’, or ‘ignore’ as opt-in indicator.
The default is ‘ignore’ which means no opt-in indicator is relevant.
</xs:documentation>

</xs:annotation>

<xs:restriction base=“xs:token”>

<xs:pattern value=“willing|ignore”/>

</xs:restriction>

</xs:simpleType>
<!-- NetType -->
<xs:simpleType name=“NetType”>

<xs:restriction base=“xs:string”>

<xs:pattern value=“IMS|SIP|[a-zA-Z][a-zA-Z0-9][a-zA-Z0-9]+”/>

</xs:restriction>

</xs:simpleType>
<!-- ApplicableNetworkType indicator -->
<xs:simpleType name=“ApplicableNetworkType”>

<xs:annotation>

<xs:documentation>
Policy: applicable-network-type
Indicator of applicable network type(s) for the given

communication service.

</xs:documentation>

</xs:annotation>

<xs:list itemType=“NetType”/>

</xs:simpleType>
<!-- Threshold indicator types -->
<xs:complexType name=“BaseThresholdType” abstract=“true”>

<xs:annotation>

<xs:documentation>
Base type definition for threshold types. Specifies ‘label’ which
is used to identify the specific threshold, along with the qualified name.

</xs:documentation>
</xs:annotation>
<xs:all>

<xs:element name=“label” type=“xs:token”/>
<xs:element name=“qn-elem” type=“xs:QName”/>
<xs:element name=“value” type=“xs:anyType”/>

</xs:all>

</xs:complexType>
<xs:complexType name=“ThresholdEqType”>

<xs:annotation>

```
<xs:documentation>
  Policy: threshold-value-equals
  Comparison operation (equality) threshold for ‘label’ for qualified
  element name ‘qn-elem’ with value specified as ‘value’.
</xs:documentation>
```

</xs:annotation>
<xs:complexContent>

<xs:extension base=“BaseThresholdType”/>

</xs:complexContent>

</xs:complexType>
<xs:complexType name=“ThresholdLtType”>

<xs:annotation>

```
<xs:documentation>
  Policy: threshold-value-less-than
  Comparison operation (less-than) threshold for ‘label’ for qualified
  element name ‘qn-elem’ with value specified as ‘value’.
</xs:documentation>
```

</xs:annotation>
<xs:complexContent>

<xs:extension base=“BaseThresholdType”/>

</xs:complexContent>

</xs:complexType>
<xs:complexType name=“ThresholdGtType”>

<xs:annotation>

```
<xs:documentation>
  Policy: threshold-value-greater-than
  Comparison operation (greater-than) threshold for ‘label’ for qualified
  element name ‘qn-elem’ with value specified as ‘value’.
</xs:documentation>
```

</xs:annotation>
<xs:complexContent>

<xs:extension base=“BaseThresholdType”/>

</xs:complexContent>

</xs:complexType>
<!-- Unavailable activities indicator -->
<xs:simpleType name=“UnavailActivityType”>

<xs:annotation>

```
<xs:documentation>
  Policy: unavailable-activities-set
  Used to describe all activities related to an application or enabler
  that would render an individual unavailable.
</xs:documentation>
</xs:annotation>
```

<xs:list itemType=“xs:QName”/>

</xs:simpleType>
<!-- UndefServCapsSubElems indicator -->
<xs:simpleType name=“UndefServCapsSubElemsType”>

<xs:annotation>

```
<xs:documentation>
  Policy: undef-servcaps-sub-elements
  Indicate how to interpret the absence or omission of specific
  &lt;servcaps&gt; sub-elements in presence metadata. Value of ‘unknown’
  is considered the default which does not give the context any
```

hints as to how to deal with missing/absent
&lt;servcaps&gt; sub-elements.

</xs:documentation>

</xs:annotation>
<xs:restriction base=“xs:token”>

<xs:pattern value=“unknown|unsupported”/>

</xs:restriction>

</xs:simpleType>
<!-- UndefBarringState indicator -->
<xs:simpleType name=“UndefBarringStateType”>

<xs:annotation>
<xs:documentation>

Policy: undef-barring-state
Indicate how to interpret the absence or omission of specific
&lt;barring-state&gt; sub-elements in presence metadata.

</xs:documentation>
</xs:annotation>
<xs:restriction base=“xs:token”>

<xs:pattern value=“ignore|active|terminated”/>

</xs:restriction>

</xs:simpleType>

```
  <!-- UndefRegistrationState indicator -->
  <xs:simpleType name=“UndefRegistrationStateType”>
```

<xs:annotation>
<xs:documentation>

Policy: undef-registration-state
Indicate how to interpret the absence or omission of specific
&lt;registration-state&gt; sub-elements in presence metadata.

```
  Default value of ‘ignore’ indicates that the sub-element has
  no meaning in this context.
```

</xs:documentation>
</xs:annotation>

<xs:restriction base=“xs:token”>

<xs:pattern value=“ignore|active|terminated”/>

</xs:restriction>
</xs:simpleType>
<!-- UndefWillingnessType indicator -->
<xs:simpleType name=“UndefWillingnessType”>

<xs:annotation>

<xs:documentation>

Policy: undef-willingness
Indicator of how to interpret absence or omission of
&lt;willingness&gt; sub-element for the given service.
Default value is ‘closed/indefinite’.

</xs:documentation>

</xs:annotation>
<xs:restriction base=“xs:token”>

```
  <xs:enumeration value=“open/indefinite”/>
  <xs:enumeration value=“closed/indefinite”/>
  <xs:enumeration value=“open/time-ofs-value”/>
  <xs:enumeration value=“closed/time-ofs-value”/>
```

</xs:restriction>

</xs:simpleType>

</xs:schema>

The above XML schema provides for the definition of element name in the lines that begin <xs:element name=“opt-in-source” type=“OptInSourceType”/>. The element names are further defined for the remaining policies in Table 1 above.

As will be seen by those skilled in the art, the remainder of the XML Schema above defines the policy types as indicated by the description and value fields in Table 1. Specifically, for the “OptInSourceType” a xs:pattern value is set to willing or ignore. The above therefore provides the additional XML type and element definitions in order to extend PEL common policy actions.

By extending common policy actions, P/CAM policies may be incorporated into a common policy PEL ‘ruleset’ XML document. A ‘ruleset’ may apply at a user scope or a global scope. For example, the ‘ruleset’ may apply to a class of service or a specific application. The ruleset may also apply to an individual user or group of users.

P/CAM related policies are manipulated and evaluated through the various PEEM requestor interfaces by the P/CAM server itself or a P/CAM enabled client/agent. That is, application or authentication protocols may provide specific metadata such as the requestor identity to the PEEM requestor interface along with other metadata available to the PEEM servers as the basis for applying rules.

The following is an example of a common policy PEL rule set XML document, which consists of a single rule ‘a101’. This rule associates with a service enabler such as a PoC alert and defines specific policy settings/values be applied as a result of a match for a target resource. In this case the target resource is the service identifier itself. As will be appreciated by those skilled in the art, this example makes an intentional correlation between the value of the common policy extension ‘ext:service[@enabler]’ attribute and the OMA PoC alert service-id as defined by OMA presence.

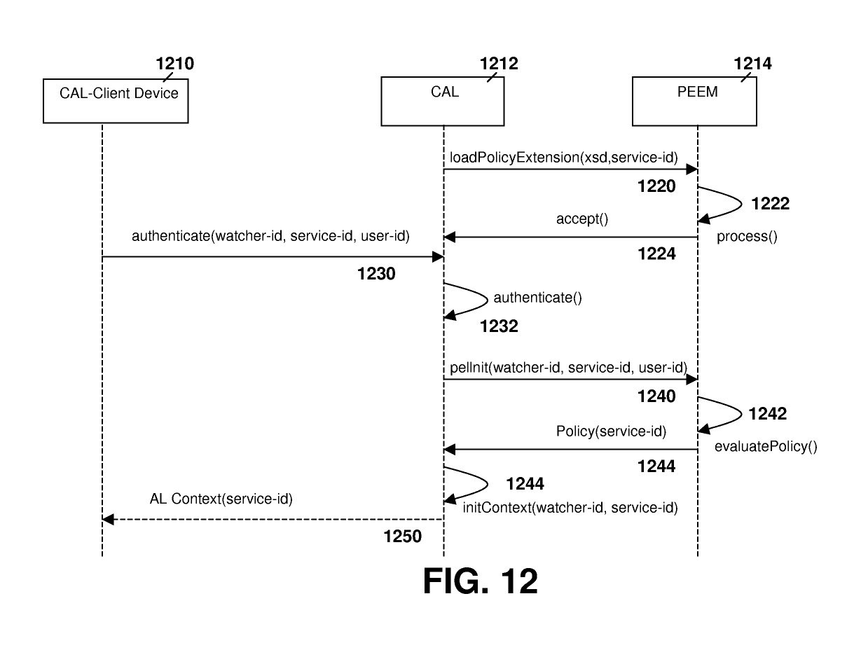

The above is illustrated with reference to FIG. 12, which shows how a context aware layer (CAL) can preload a given set of policy-type XSD. As will be appreciated, these are types as shown by Table 1 above.

A CAL-client device 1210 communicates with a CAL 1212, which communicates with a PEEM 1214.

CAL 1212 sends a loadPolicyExtension(xsd,service-id) message 1220 to PEEM 1214 which is processed, as shown by arrow 1222. PEEM 1214 then sends an accept message 1224 to CAL 1212.

At some later point the CAL-enabled client 1210 attempts to initiate and authenticate with a CAL 1212 service enabler such as a PoC alert service. This is done with the authenticate (watcher-id, service-id, user-id) message 1230.

As part of the initiation and authentication the CAL 1212 sends a pelInit (watcher-id, service-id, user-id) message 1240 to PEEM 1214. PEEM 1214 evaluates the policy as shown by arrow 1242 and returns the policy in message 1244. Evaluation 1242 allows the PEEM to apply a specific set of policy settings on a per server or per user basis.

CAL 1212 initiates the context arrow 1244 and further optionally returns the CAL context as message 1250 back to CAL client device 1210.

It is possible that, as an example, the match criteria could be the service-id relating to an OMA enabler (such as PoC alert). Other match criteria could be based on a user or a group sphere.

<?xml version=“1.0” encoding=“UTF-8”?>
<!-- Sample policy ruleset for OMA PoC Alert service. -->
<!—- A ruleset may apply on a per-user or global basis. -->
<cr:ruleset xmlns=“urn:ietf:params:xml:ns:common-policy”

```
  xmlns:ext=“urn:oma:xml:xdm:extensions”
  xmlns:cr=“urn:ietf:params:xml:ns:common-policy”
```

xmlns:cs=“urn:oma:xml:xdm:extensions:cam”
xmlns:rpid=“urn:ietf:params:xml:ns:pidf:rpid”>

<!-- A rule for PoC alert service, establish context policies -->

<cr:rule id=“a101”>

<cr:conditions>

<ext:service-list>

<!—Match against a specific OMA enabler by service-ID... -->

```
  <ext:service enabler=“org.openmobilealliance.PoC-alert”/>
  </ext:service-list>
</cr:conditions>
<cr:actions>
```

<!-- Following policy values for document scope... -->

```
<cs:undef-servcaps-sub-elements>
  unsupported
</cs:undef-servcaps-sub-elements>
<cs:undef-willingness>
  closed/indefinite
</cs:undef-willingness>
<cs:opt-in-source>willing</cs:opt-in-source>
<cs:unavailable-activities-set>
  rpid:busy rpid:sleeping
</cs:unavailable-activities-set>
<cs:undef-registration-state>
```

terminated

</cs:undef-registration-state>
<cs:undef-barring-state>

ignore

</cs:undef-barring-state>
<cs:applicable-network-type>

IMS

</cs:applicable-network-type>

</cr:actions>

</cr:rule>

</ruleset>

As will be appreciated by those skilled in the art, the above defines rule ‘a101’. In this case the service-id is defined as “org.openmobilealliance.PoC-alert” the OMA PoC Alert service, and the P/CAM policy extensions are defined as part of the XML namespace “urn:oma:xml:xdm:extensions:cam”. The above is therefore a manifestation of the schema defined with regard to Table 1 above. The context aware layer values based on rule ‘a101’ firing are shown below with reference to Table 1A.

TABLE 1A
Policy Setting/Values (OMA PoC Alert Service)

| Policy | Value |
|---|---|
| opt-in-source | willing |
| applicable-network-type | IMS |
| unavailable-activies-set | rpid:busy rpid:sleeping |
| undef-servcaps-sub-elements | unsupported |
| undef-barring-state | ignore |
| undef-registration-state | terminated |
| undef-willingness | (closed,indefinite) |

As will be appreciated the PEEM could utilize multiple application policies and multiple services or exclusions could be established as part of a ruleset.

The actions as seen in the XML above define specific policy values for document scope.

### Aspects:

Aspects are application level abstractions relevant to a source, for example, presence aspects are application level abstractions relevant to presence. Presence aspects can be considered the conceptual interface of a presence context to a P/CAM client application or enabler. Table 2 below outlines a base set of applicable presence aspects that may be incorporated for use by a presence context aware mechanism and exposed to client applications. For each presence aspect, a description is provided, along with the associations the aspect relates to in terms of the standard presence data model outlined in IETF rfc 4479.

In particular, to specify and apply contextually relevant behavior across a disparate set of interworking components and user devices, a general mechanism for the encapsulation of aspects related to a presence platform is employed. That is, an aspect captures a first-order abstraction related to a given application or enabler. Aspects relating to a presence platform would describe or relate to underlying indications of presence. Aspects may be expanded to encapsulate other indications as well. For example, location may be incorporated (or inferred) to derive or compute an associated aspect within a presence platform. This is illustrated in Table 2 below with regard to the who-is-nearby aspect.

The present disclosure provides a mechanism for an arbitrary number of aspects to be employed by the presence platform. These may include common aspects such as availability and reachability. They may also include application specific aspects. A mechanism within the presence platform or management interface exists to associate an appropriate set of aspects with a given service. Association of aspects of contextual in nature and may apply at different levels. For example, a given aspect may apply to a service enabler such as all OMA push-to-talk over cellular (i.e. PoC) compliant service.

An aspect may also be applicable at a user or group level.

For each aspect, an associated set of rules or logic may be defined which outline the steps or processing to achieve the given aspect. The logic also identifies the raw presence/data indicators/elements relevant to the calculation of the associated aspect. A given aspect may combine two or more predefined rules together as part of its logic processing. Further, underlying logic may be reused as a library or routines in support of aspects within a presence platform. This library may include aspects as other high-level modules or components which may be incorporated. This allows multiple client application types to utilize a context aware layer.

In one embodiment presence aspects are extensible. For example, if a given service or enabler specified or otherwise employs specific functionality, the presence platform could support the extension or re-definition in one or more aspects

As will be appreciated by those skilled in the art, Table 2 may be modified or extended to support other presence platforms or application/enabler requirements. The particular presence aspects shown in Table 2 are demonstrative of an OMA presence platform. Those skilled in the art would also appreciate that the extending or modification could be achieved through a SIP SUBSCRIBE/NOTIFY to/from the OMA PRS platform.

TABLE 2
Presence Aspects

| Presence | | | | Common |
|---|---|---|---|---|
| Aspect | Description | Associations | Visibility | visibility |
| opt-in | Presentity is willing to | Person −> | OTA, | Server |
| | participate in a | service. | Server | |
| | session for a given | | | |
| | service or application. | | | |
| available | Presentity is available | Person −> | OTA, | Server |
| | to communicate using | service. | Server | |
| | a given service or | | | |
| | application. | | | |
| contact-means | Presentities most | Person(addr) −> | OTA, | Server |
| | applicable method of | service. | server | |
| | contact for a given | | | |
| | service or application. | | | |
| contactable | Presentity is willing, | Person(addr) −> | OTA, | Server |
| | available, and has a | service. | server | |
| | currently valid contact | | | |
| | means for a given | | | |
| | service or application. | | | |
| reachable | Presentity is | Person −> service −> | OTA, | OTA |
| | contactable for a | device | server | |
| | given Service or | | | |
| | application. | | | |
| | NOTE: A positive | | | |
| | indication for | | | |
| | reachable is indicates | | | |
| | that a presentity is | | | |
| | willing, available, | | | |
| | contactable, and their | | | |
| | device is in-coverage | | | |
| | to establish | | | |
| | communication over | | | |
| | the defined service. | | | |
| where-are-you | Presentities current | Person, | OTA, | OTA |
| | location. | Person −> service −> | server | |
| | | device | | |
| personal-avatar | Presentities current | Person | OTA, | OTA |
| | personal iconic | | server | |
| | representation. | | | |
| service-avatar | Presentities current | Person −> service | OTA, | OTA |
| | iconic representation | | server | |
| | for a given service or | | | |
| | application. | | | |
| personal-interests | Presentities current | Person(extended- | OTA, | Server |
| | interests or hobbies. | info) | server | |
| who-is- | Watchers that | Winfo | OTA, | Server |
| subscribing-to-me | currently have | | server | |
| | ‘pending’ | | | |
| | subscriptions for a | | | |
| | given presentity. | | | |
| who-is-nearby | A list of zero or more | Person −> service | OTA, | Either |
| | presentities that are | | server | |
| | within close proximity | | | |
| | and meet an optional | | | |
| | set of criteria (e.g. | | | |
| | interested in football). | | | |
| who-is-blocked | Watchers who have | Winfo, common- | OTA, | Server |
| | had subscriptions | policy | server | |
| | terminated or have | | | |
| | been blocked for a | | | |
| | given presentity | | | |
| eligible-session- | Whether a presentity | Person −> service −> | OTA, | Server |
| participant | is reachable and | device, | Server | |
| | meets an optional set | Shared | | |
| | of criteria in order to | UserProfile, | | |
| | participate in a | Other XDMS | | |
| | session of the | meta-data | | |
| | associated service. | | | |
| Session- | An indicator of | Person −> service | OTA, | OTA |
| answermode | whether a presentity | | Server | |
| | will accept an | | | |
| | incoming session for | | | |
| | a given service in | | | |
| | automatic (no | | | |
| | intervention) or | | | |
| | manual (user must | | | |
| | accept/reject) mode. | | | |
| what-are-you- | Presentities current | Person. | OTA, | Server |
| doing | activity. | | Server | |
| active-barring | An indicator of | Person −> | OTA, | Server |
| | whether a Presentity | service. | Server | |
| | is actively barred or | | | |
| | not for the given | | | |
| | comm. service. | | | |
| active- | An indicator of | Person −> | OTA, | Server |
| registration | whether a | service. | Server | |
| | presentity is | | | |
| | actively registered | | | |
| | for the given | | | |
| | comm.. service. | | | |
| how-are-you | Presentities current | Person. | OTA, | OTA |
| | mood. | | Server | |
| time-zone | Presentities current | Person. | OTA, | OTA |
| | timezone. | | Server | |
| network- | Presentities current | Person −> service −> | OTA, | OTA |
| availability | network availability | device | Server | |
| | for an associated | | | |
| | comm. device. | | | |
| preferred- | Presentities relative | Person −> service | OTA, | Server |
| service | service preference. | | Server | |
| involved- | Whether a presentity | Person −> service | OTA, | Server |
| session | is currently involved | | Server | |
| | in a session of the | | | |
| | associated service. | | | |
| session-count | Total number of | Person | OTA, | OTA |
| | communication | | Server | |
| | sessions presentity is | | | |
| | involved in. | | | |
| device- | The current | Device | OTA, | OTA |
| orientation | orientation of the | | Server | |
| | device | | | |
| device- | The current | Device | OTA, | OTA |
| capabilities | capabilities of the | | Server | |
| | device | | | |

Table 2 defines various presence/application/service aspects applicable to a presence platform. For each aspect there is a short description along with the association or applicability of the aspect to the standard presence data model. In addition, the visibility is declared. Visibility describes the applicable point at which the associate aspect is referred to. Common visibility defines or declares the most common or relevant point at which the associated aspect is likely to be referred. Choices for visibility include over the air (OTA) versus server. As would be appreciated, “server” would surface on the network side in an application server.

In the first row of Table 2 above, the opt-in aspect is defined which indicates that the presentity is willing to participate in a given session for a given service or application. As indicated in Table 2, the person is associated with the service.

A second row of Table 2 indicates that a presence aspect is ‘available’. This aspect indicates that the presentity is available to communicate using a given service or application and again there is an association between the person and the service.

The next row in Table 2 indicates the presence aspect of contact-means. A presentity's most applicable method of contact for a given service or application is provided and the association is between the person's address and the service.

The next row of Table 2 indicates an aspect of ‘contactable’. This aspect shows whether the presentity is willing, available and has currently valid contact means for a given service or application. Again, in this case, the association is between the address of a person and the service.

The next row of the table indicates an aspect of ‘reachable’. This shows that the presentity is contactable for a given service or application. A positive indication for reachable shows that a presentity is willing, available, contactable and that their device is in coverage to establish communication over the defined service. The association is therefore between the person, service and the device.

‘Where-are-you’ is the next aspect defined in Table 2 and shows the presentity's current location. As indicated, the association for this aspect is at the person, and the person, service, and the device.

Other aspects are further defined in Table 2 and include various associations thereto.

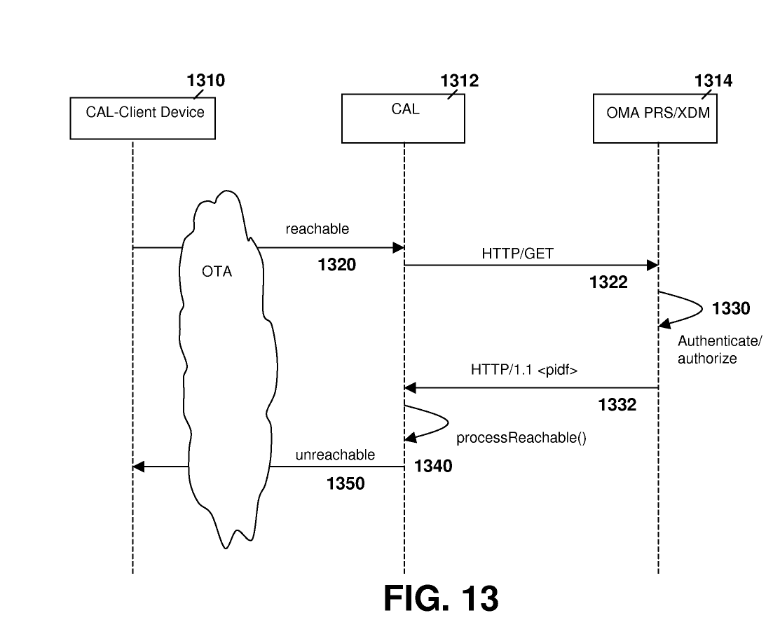

For an OMA presence realization, a presence platform call flow may look like that described in FIG. 13. Those skilled in the art will appreciate that FIG. 13 shows that the context aware layer sits between a client device and the OMA presence/XDM layer. In one embodiment, the access layer can be an application layer. Such a context aware layer could be a separate layer or an internal layer of the application (for example a mobile advertising application with a split or integrated context aware layer).

As shown in FIG. 13, the aspect “reachable” may include, in the back end, further processing which incorporates rules and possibly the use of other aspects, rules and/or policy in the computation. As previously noted, these aspects may exist within a standard library of aspects for reuse within higher level applications or service aspects when required.

Reference is now made to FIG. 13. FIG. 13 shows a client device 1310 which communicates with a context aware layer 1312, which in turn communicates with an OMA PRS/XDM entity 1314.

Client device 1310 sends a query concerning the presence aspect “reachable”, shown as communication 1320. In turn, context aware layer 1312 sends an HTTP/GET request 1322 to OMA PRS/XDM 1314. Those skilled in the art would also appreciate that this could be achieved through a SIP SUBSCRIBE/NOTIFY to/from the OMA PRS platform.

OMA PRS/XDM 1314 authenticates as shown by 1330 and returns a response in the form of HTTP/1.1 <pidf> 1332.

The context aware layer 1312 then checks whether the process is reachable as shown by arrow 1340. The processing within the CAL for the aspect “reachable” invokes other rules such as “contactable”, “contact-means”, “available” and “opt-in or willing”. Rules may refer to or incorporate policy including “opt-in-source”, and “undef-willingness” in the calculation of aspect “reachable”.

The arrow shown by 1340 determines that the presentity is unreachable and returns this in message 1350.

As shown in FIG. 13 reachable query 1320 and unreachable response 1350 travel over the air. However, this is meant only as an example and other communications techniques would be applicable in different embodiments.

### Rules/Triggers:

A third branch of the context awareness mechanism solution consists of rules and/or triggers. The example below uses presence as an example.

Rules reside within a presence context and establish a sequence of steps or logic flows to compute presence aspects based on the metadata provided by the underlying presence platform. Rules are conceptually similar to database stored procedures or user defined functions (UDFs). Base or default presence rules may be changed or supplemented by an application client or an individual user. For example, the injection by a client of dynamic rules may override or extend base rule behavior. In addition, rules incorporate policies associated with the presence context by the application or the enabler to augment or provide hints surrounding the interpretation of metadata. This permits an application or service to directly affect the outcome of one or more presence aspects, as required.

Table 3 below shows a set of rules relating to computation of presence related aspects with pseudo-logic specific to the OMA presence platform. It should be noted that this is only a subset of the rules/logic that may be exposed by a presence context. It is possible to change the composition or granularity of rules depending on the presence context. In addition, as noted with reference to FIGS. 3-6 above, it is possible for a presentity or watcher to continue to fetch or be notified of raw presence information by the underlying presence platform in order to reach specific conclusions if context is not applicable. This could, as would be appreciated, occur in specific situations.

As used in Table 3 below, ‘def’ indicates “defined” and means that the entity exists and is established with reasonable values. ‘undef’ means “undefined” and means the complement of ‘def’. ‘Undef’ thus has values such as nil, null, or invalid.

‘Valid’ in Table 3 below means the associated entity still contains timely or meaningful data.

TABLE 3
Rules

| Rule | Description | Pseudo-logic |
|---|---|---|
| FindServicePresInfo | Return most applicable pres. | For each <tuple> ‘t’ in list with t.service- |
| | information element ‘svc’ for the given | id == service-id |

| | |
|---|---|
| service or application within | Items.add(‘t’) |

| | |
|---|---|
| service ‘list’. | If Items.size == 1 |

| | |
|---|---|
| NOTE: pseudo-logic method | Res=Items[0] |

| | |
|---|---|
| ‘resolveService( )’ implements | Else |

| | |
|---|---|
| semantics outlined in OMA-TS-Pres | Res=resolveService(Items) |

| | | |
|---|---|---|
| | V2_0 Section (5.2.3). | Return Res |
| hasOptedInForService | Makes use of opt-in-source policy to | Switch (opt-in-source policy) |
| | establish a user ‘p’ willingness to | Case willing: |

| | |
|---|---|
| communicate given a service or | Uwp=undef-willingness policy |
| application ’svc’. Willingness is an | If svc.willingness undef |

| | |
|---|---|
| ordered pair (open\|closed, | Return Uwp |

| | |
|---|---|
| indefinite\|time-ofs-value). | Else |

| | |
|---|---|
| NOTE: pseudo-logic method | Return svc.willingness |

| | |
|---|---|
| implements semantics outlined | Case session-participation: |

| | |
|---|---|
| in OMA-TS-Pres V2_0 Section | Return Willingness(svc.session- |
| (10.4.1). | participation, indefinite) |

Default: // ignore

Return Willingness(open,
indefinite)

| | | |
|---|---|---|
| isAvailable | Return boolean value indicating | Urs=undef-registration-state policy |
| | whether a presentity ‘p’ is | Ubs=undef-barring-state policy |
| | available to communicate for a | Uas=unavailable-activities-set policy |
| | given Service or applicaiton ‘svc’. | If (p.activities valid and <activities> non- |
| | NOTE: pseudo-logic method | empty-set) |

| | |
|---|---|
| implements semantics outlined | For each <activities> ‘a’ in p: |

| | |
|---|---|
| in OMA-TS-Pres V2_0 Section | If (‘a’ match 1+ element |
| (10.4.3). The logic in this method also | in Uas) |

| | |
|---|---|
| factors in activity (if directed to by | Return false |

| | |
|---|---|
| policy) into availability | If (svc.reg-state undef) |

| | |
|---|---|
| calculation. | If (Urs == ‘ignore’) |

Reg-state=active

Else

Reg-state=Urs

Else

Reg-state=svc.reg-state

If (svc.bar-state undef)

If (Ubs == ‘ignore’)

Bar-state=active

Else

Bar-state=Ubs

Else

Bar-state=svc.bar-state

If (Reg-State == ‘active’ AND Bar-state
== ‘active’ AND svc.status.basic ==
‘open’)

Return true

| | | |
|---|---|---|
| | | Return false |
| establishContactMeans | Return applicable contact ‘c’ for a | Return svc.contact |
| | given a service or application service | |
| | ‘svc’. | |
| | NOTE: pseudo-logic follows rfc | |
| | 3863. | |
| isContactable | Return a valid ContactMeans | W = hasOptedInForService(p,svc) |
| | consisting of the tuple | If (W valid AND isAvailable(p,svc)) |

| | |
|---|---|
| (contact, Idev, validity) if a presentity ‘p’ | C = |
| is contactable for a given service or | establishContactMeans(svc) |
| applicaiton‘svc’. | If (C def AND svc.deviceID def) |

| | |
|---|---|
| NOTE: pseudo-logic method | Cm=ContactMeans( |

| | |
|---|---|
| implements semantics outlined | Contact, svc.deviceID(s), |
| in OMA-TS-Pres V2_0 Section | w.validity) |

| | |
|---|---|
| (10.4). | Return Cm |

| | | |
|---|---|---|
| isReachable | Return boolean value indicating | Ant=applicable-network-type policy |
| | whether an applicable device | If (cm valid) |

| | |
|---|---|
| ‘dev’ may be reached over the | For each ‘d−>deviceID’ in Idev: |

| | |
|---|---|
| required network type given a | Find ‘dev’ in <device> |
| contactable contact-means. | elements where |
| | dev.deviceID == ‘d− |
| | >deviceID’ |
| | If match |

For each
<network> ‘n’
in ‘dev’:
If (‘n’.id match
1+ element in
Ant and ‘n’
available)
Return true

Return false

The table above describes a number of rules. The first rule defined is ‘findServicePresInfo’ which returns the most applicable presence information element for the given service or application within a service list. As indicated in the pseudo logic, for each tuple t in the list, a check is made to see whether the service-id of ‘t’ matches the desired service-id, and if so the tuple t is added to a list. Thereafter, once the compilation is finished, if the item size is 1 then that item is returned. Otherwise the function ‘resolveService’ is invoked. As will be appreciated by those skilled in the art, the ‘resolveService’ function is an OMA specific function that finds the most relevant service.

Similar rules are defined with regard to the remainder to the Table 3, in which various pseudo logics are utilized to define what will be returned when a rule is implemented.

Presence rules and/or logic flows may be specified using OMA's PEEM/PEL. The following is an example of a PEEM/PEL ‘abstract process’ document which characterizes the logic flow for the ‘findServicePresInfo’ rule as shown in the pseudo-logic of Table 3 above:

<process name=“findServicePresInfo”

targetNamespace=“http://example.com/ws-bp/purchase”
xmlns=“http://docs.oasis-open.org/wsbpel/2.0/process/abstract”
xmlns:pcam=“http://pcam.example.com/wsdl/oma-pres-pcam”>

<documentation xml:lang=“EN”>

A WS-BPEL process for finding the appropriate service tuple(s).

</documentation>
<!-- Input/output parameters: -->
<!-- presinfo - inbound body containing service-ID, and presence info -->
<!-- theResult - the most relevant service tuple for service-ID -->
<variables>

<variable name=“presinfo” messageType=“##opaque”/>
<variable name=“matchingTupleList” messageType=“##opaque”/>
<variable name=“theResult” messageType=“##opaque”/>

</variables>
<partnerLinks>

<partnerLink name=“service” partnerLinkType=“##opaque”

partnerRole=“##opaque“/>

<partnerLink name=“customer” partnerLinkType=“##opaque”

partnerRole=“##opaque”
myRole=“##opaque”/>

</partnerLinks>
<sequence>

<receive partnerLink=“customer” operation=“findServicePresInfoRequest”

variable=“presinfo” createInstance=“yes”>

</receive>
<forEach counterName=“i” parallel=“no”>

| <!-- Iterate over $presinfo.msg/tuple and find all matches --> | |
|---|---|
| <!-- between $presinfo.msg/service-id and | --> |

| <!-- $presinfo.msg/tuple[i]/service-description/service-id --> | |
|---|---|
| <!-- Store in matchingTupleList | --> |

</forEach>
<if>

<condition opaque=“yes”>$matchingTupleList.num-items == 1</condition>
<flow>

<!-- $theResult is the first item in $matchingTupleList -->

</flow>
<else>

<!-- $theResult is the outcome of invoking resolveService -->
<!-- method with $matchingTupleList -->

</else>

</if>
<reply partnerLink=“service” portType=“##opaque”

operation=“##opaque” variable=“theResult”>

</reply>

</sequence>

</process>

The other portion of the rules/triggers branch is triggers. Triggers reside within a presence context and associate a sequence of steps (or logic flows) based on an underlying presence state change detected in the presence platform. Triggers are conceptually similar to database triggers. Triggers are, by default, initially notifications. Triggers may be defined by an application client, or an individual user as needed. For example, the injection by a client of dynamic triggers may override or extend base trigger behavior(s). As would be appreciated by those in the art, presence triggers monitor for detected presence aspect value changes. The rules are the same underlying rules as for a given presence aspect (e.g. rules for ‘reachable’ and ‘onUnreachable/Reachable’ are very similar). A difference between the two is that when a trigger is detected, there is also an associated ‘rule’ which specifies a pre-defined action, such as, when an action fires, and sends the watcher (P/CAL or AL client) a notification of the associated presence aspect value change.

Table 4 lists a set of triggers relating to the computation of presence related aspects with pseudo-logic specific to the particular trigger. It should be noted that all existing aspects may also be defined with a corresponding trigger definition.

TABLE 4
Triggers

| Trigger | Description | Pseudo-logic |
|---|---|---|
| onOptIn/Out | Application defined | notification(default) |
| | trigger which is | |
| | invoked when a | |
| | presentity is | |
| | determined to have | |
| | opted-in/out for the | |
| | given service or | |
| | application | |
| onUn/Available | Application defined | notification (default) |
| | trigger which is | |
| | invoked when a | |
| | presentity is | |
| | un/available for the | |
| | given service or | |
| | application. | |
| onUn/Reachable | An application | notification (default) |
| | defined trigger | |
| | which is invoked | |
| | when a presentity | |
| | is un/reachable for | |
| | the given service | |
| | or application. | |
| onNearby/onOutOfRange | Invoked when a | notification (default) |
| | presentity is nearby | |
| | or they have moved | |
| | out of a specified | |
| | range for the given | |
| | service or | |
| | application. | |
| on-pending-subscription | Invoked when a | notification w/list<AOR> (default) |
| | presentity has one | |
| | or more | |
| | subscriptions in a | |
| | ‘pending’ state. | |
| on-terminated-subscription | Invoked when a | notification w/list<AOR> (default) |
| | presentity has one | |
| | or more | |
| | subscriptions in a | |
| | ‘terminated’ state. | |
| on-update-note | When a presentity | notification w/note-text (default) |
| | adds or updates a | |
| | personal note. | |
| on-is-in/eligible-session- | When a presentity | notification (default) |
| participant | is un/reachable and | |
| | in/eligible for the | |
| | given service or | |
| | application. | |
| on-activity-update | When a presentity | OTA Notification w/activity-text |
| | adds or updates | (default) |
| | an activity. | |
| on-barred-active/on- | When a presentity | OTA Notification (default) |
| barred-terminated | is barred | |
| | (active)/un-barred | |
| | (terminated) for the | |
| | given comm. | |
| | service. | |
| on-registration-active/on- | When a presentity | OTA Notification (default) |
| registration-terminated | is registerd | |
| | (active)/un- | |
| | registered | |
| | (terminated) for the | |
| | given comm. | |
| | service. | |
| on-location-change | When a presentity | OTA Notification w/location |
| | is determined to | information (default) |
| | have changed | |
| | location (e.g. geo- | |
| | coordinates, or | |
| | location tag) for | |
| | the associated | |
| | comm. service. | |
| on-icon-change | When a presentity | OTA Notification w/icon URI (default) |
| | is determined to | |
| | have changed their | |
| | icon (e.g. their | |
| | person or service | |
| | related icon). | |
| on-mood-change | When a presentity | OTA Notification w/mood information |
| | is determined to | (default). |
| | have changed their | |
| | personal mood. | |
| onNetworkAvailable/UnAvailable | When a presentity | OTA Nofification w/network |
| | device is detected | home/visited network indicator |
| | to be network | (default). |
| | available/un- | |
| | available | |
| | (applicable to a | |
| | home or visited | |
| | network). | |
| on-icon-metadata-change | When the | OTA Notification w/tuple - icon URI, |
| | associated icon | metadata change(s) (default) |
| | metadata (e.g. | |
| | contenttype, etag) | |
| | changes for a | |
| | given presentity. | |
| on-relative-service- | When a | OTA Notification (default) |
| preference-change | presentity's | |
| | relative service | |
| | preference has | |
| | changed. | |
| on-session- | When a presentity | OTA Notification w/service identifier |
| involved/uninvoled | is currently | (default) |
| | involved | |
| | (participating)/unin- | |
| | volved (not | |
| | participating) in an | |
| | associated session | |
| | of the given comm. | |
| | service. | |
| on-session-count-change | When total number | OTA Notification w/total number of |
| | of communications | sessions |
| | sessions presentity | |
| | is involved in | |
| | changes | |
| on-timezone-change | When a presentity | OTA Notification w/time-offset (default) |
| | is determined to | |
| | have changed | |
| | timezone (relative | |
| | to UTC). | |
| on-personal-interest- | When a presentity | OTA Notification w/personal-interest |
| change | is determined to | update (default) |
| | have changed their | |
| | personal interests | |
| | (e.g. hobbies). | |

The first trigger in Table 4 above indicates that the trigger will be invoked when a presentity opts in or out of a given service or application. The trigger allows specific functionality to be carried out when the associated state occurs within the context. The pseudo-logic can be defined by the application client if the client wishes the P/CAM to do something on the occurrence of a given event which is when a trigger is invoked.

The other triggers defined by Table 4 have similar functionality and are invoked pursuant to a predefined condition being met.

Triggers are specified using OMA's PEEM/PEL (Policy Expression Language) and are identical (in structure and composition) to presence rules. Thus the code example used above with reference to rules could be adapted for the triggers of Table 4.

Triggers are important in a complex presence-aware system. Triggers provide a network initiated encapsulation to be defined and applied for a given scenario. Triggers, in one embodiment, provide a simple notification to a client or service or may incorporate complex business logic that is executed completely within the network. This is important within a wireless domain where network bandwidth and processing resources are limited.

For example, a wireless content delivery service may require specific behavior based on the state of users and their associated device capabilities. That is, two users who have opted in for a sports ticker/alert service with different devices may receive content in different ways. For example, a first user who has a very simple text based wireless device and is only able to receive short message service (SMS) with baseball related content and/or a web-based URL pointing to additional information requires different data than a second user who has a full featured personal digital assistant/smart phone with a built in media handling capability. The second user may receive multimedia alert messages containing short full-color video clips of a sports ‘play of the day’.

Each case above illustrates the underlying complexity required of a content delivery service to deliver appropriate/timely content relevant to each user's device. That is, a content delivery service is required to have some understanding of a given user's current state, along with their associated interests, and the relevant device capabilities for receiving content. A content delivery service working in combination with a contextually aware presence capability is such a platform. Further, a contextually aware platform that exposes relevant “aspect triggers” on behalf of a content delivery service provides a novel means for notifying or pushing relevant information to an associated subscriber base.

An aspect with an associated trigger is a “monitored aspect” on a continuous or specified basis. That is, when an entity, whether a person or a logical entity, reaches or qualifies for an associated aspect trigger, the associated trigger fires and a set of logics or actions (e.g., which may be pre-defined actions) takes place. The logic is contextual in nature and allows services and/or user specific actions to be defined and executed. This may be sending or pushing relevant information to an appropriate client device. As with aspects, aspect triggers may be expanded to encapsulate a variety of non-presence indicators such as location.

The present systems and methods include a mechanism for an arbitrary number of aspects to be employed by the service/presence platform. This may include a set of common aspect triggers such as “availability”, “opt-in”, “reachable”, among others, as well as application specific triggers. A method exists in one embodiment within the presence platform or management interface for associating an appropriate set of aspect triggers with a given service. Association of aspect triggers is contextual in nature and may apply at different levels. For example, a given aspect trigger may apply to a service enabler such as all OMA push-to-talk over cellular PoC compliant services. Further, the trigger may be applicable or scoped at a class of service level. For example, this may apply “availability” to all class of services. Further, a trigger may be applicable at a user or group level.

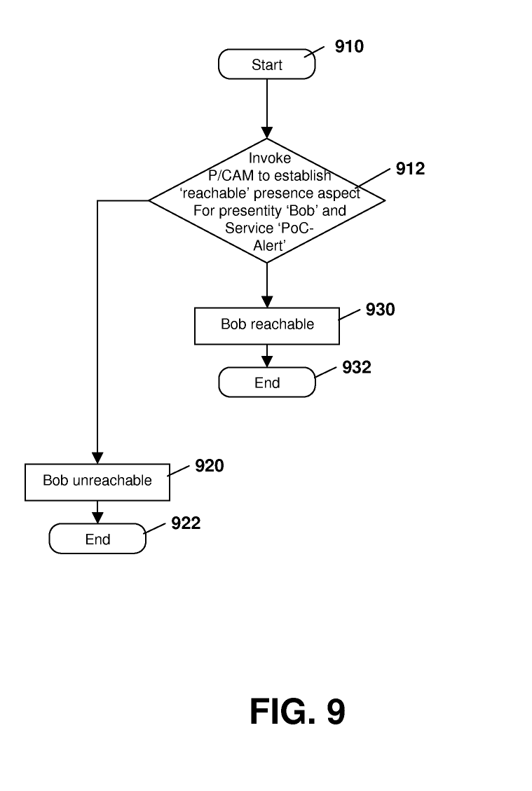

As will be appreciated with reference to FIGS. 2 and 9 above, the determination of whether a client is “reachable” is simplified for the user or client application, by abstracting the aspect to the context aware layer. Further, a trigger can invoke an action based on a detected change in the aspect value. This could be done by the underlying service enabler without any involvement from any client device. Triggers may invoke logic consisting of rules/procedures which include the invocation of methods to transmit appropriate information (e.g. aspect values) or perform or otherwise carry out some other action or function on behalf of the client device.

Aspect triggers by default will send an appropriate notification back to an associated client. However, it is possible for a service, class-of-service, enabler, user or group to modify/define a trigger which performs actions exclusively within the network without any client involvement.

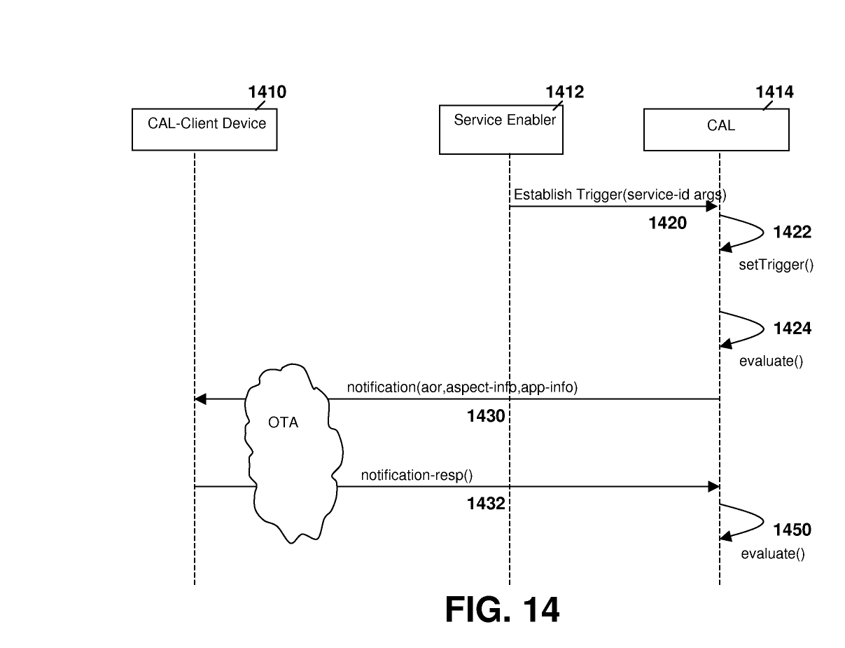

Call flow is shown below with regard to FIG. 14. Aspect triggers do not require an associated subscription on behalf of a client or service. Given triggers are calculated or derived within the network, an interested observer, whether a client device or interworking service/enabler, may receive an unprompted or asynchronous notification as a result of an aspect trigger. Notifications may be handled using different communication means. For example, a client device may receive an SMS notification as a result of an aspect trigger firing. Additionally other services may receive OMA SIP/PUSH 1.0 notification or notifications in response to an associated trigger.

The contents of a notification are specific to the trigger and could include items such as the address of record or one or more presentities, an aspect indicator or mask for one or more aspects of relevance, a URL, a service or application routing mask for the receiving entity to ensure the aspect is directed or associated with the appropriate observer, among others.

Each client or service receiving a notification may respond as required by the associated transport protocol. Additionally, it is possible for aspect trigger indications to be durable. That is, if a trigger is calculated for a given “interested observer” but that observer is unreachable, the aspect indication may be persisted or queued until the given user is able to properly receive the associated trigger. This is useful for scenarios where a given notification may outlast a given client user session.

Referring to FIG. 14, a client device 1410 communicates with a service enabler 1412 which communicates, or is integrated with an context aware layer (CAL) 1414.

As seen in FIG. 14, a trigger is established with message 1420, at which point CAL 1414 sets a trigger as shown in 1422, and evaluates the trigger as shown by arrow in 1424. As would be appreciated by those in the art, trigger 1422 could also be established based on the establishment of context (by CAL 1414) on behalf of CAL client device 1410. The first example, as shown in FIG. 14, could for example set service specific (default) triggers for a given set of users, without interaction from a client. Therefore, if a client is connected, either directly (i.e. CAL client device 1410 have overtly established context to a CAL 1414) or indirectly (i.e. CAL client device 1410 have indirectly established context via a CAL capable service 1412 within the network, to a CAL 1414), either could receive a triggered notify from the CAL 1414 without having to do anything other than being connected to their CAL capable service 1412 (i.e. have an active session ongoing with their CAL capable service).

Arrow 1422 establishes the trigger. This may include overriding or extending default steps for the trigger, obtaining/evaluating data from various sources and possibly sending out notifications to one or more users as a result of a detected change in a prescribed value.

The evaluation shown by arrow 1424 shows that when a trigger fires an address of record, an aspect or application information is packaged up and notification is sent to the CAL client device 1410 or the CAL capable service 1412 (arrow not shown). This notification to CAL client device 1410 is shown with arrow 1430.

Further, when a trigger fires it is possible for a CAL-Client device 1410 to have established or negotiated a pre-defined interface with CAL 1414. For example, the interface could specify how a CAL service should indicate the specified trigger action. That is, if the trigger pre-defined action was to start a service, the interface could specify how the CAL service should initiate that service (e.g. host:port or URI of service, authorization-parameters, other info required to kick off the service, etc.). The prescribed interface for use with CAL 1410 and CAL 1414 could also be established or resolved as part of the context.

In some cases a response is required, and this is shown by arrow 1432.

As shown in FIG. 14, the CAL 1414 could then continue to monitor or evaluate whether the trigger should fire as shown by arrow 1450.

The above policies, aspects and rules/thresholds could utilize a web services business process execution language in the form of WSBPEL 2.0. WSBPEL 2.0 provides a mechanism with which to express logical sequences required to implement presence rules or triggers (either whole or in part) in a P/CAM solution. A formal language (like PEEM/PEL) for specifying logic flows and invoking primitives (through web service description language (WSDL) type bindings) provides a presence context with limitless combinations of rules and/or triggers on behalf of an application or service. It should also be noted that more complex context flows may be created and chained together (e.g. through partner links) to carry out workflows and or business logic that is presence related and contextually relevant to the connected platform. Rules are able to invoke other rules, as nested rules. Similarly, triggers may also invoke rules where applicable.

As will be appreciated by those skilled in the art, the use of a context aware layer saves device and network resources by reducing the amount of information that flows between a mobile device and a network, and by removing processing from the mobile device.

An example of this is shown with regard to FIG. 1 above. Specifically, when Alice wishes to send a PoC alert to Bob, the following XDM fetch could made:

GET /pidf-manipulation/users/sip:bob@example.com/index/~~/tuple/service-
desciption/service-id=%22org.openmobilealliance:PoC-alert%22 HTTP/1.1

In response, a ‘raw presence document’ as illustrated below is returned:

HTTP/1.1 200/OK
Etag: “eti87”
Content-Type: application/pidf+xml
...
<?xml version=“1.0” encoding=“UTF-8”?>
<presence xmlns=“urn:ietf:params:xml:ns:pidf”

xmlns:pdm=“urn:ietf:params:xml:ns:pidf:data-model”
xmlns:rpid=“urn:ietf:params:xml:ns:pidf:rpid”
xmlns:caps=“urn:ietf:params:xml:ns:pidf:caps”
xmlns:op=“urn:oma:xml:prs:pidf:oma-pres”
xmlns:xsi=“http://www.w3.org/2001/XMLSchema-instance”
entity=“sip:bob@example.com”>

<!-- Document returned to agent, from presentity Bob... -->
<tuple id=”a1232”>

<!—- User ‘Bob’ basic availability (available)... -->

<status>

<basic>open</basic>

</status>
<!—- User ‘Bob’ willingness (willing)... -->
<op:willingness>

<op:basic>open</op:basic>

</op:willingness>
<!—- User ‘Bob’ registration state... -->
<op:registration-state>active</op:registration-state>
...
<!—- User ‘Bob’ service description... -->
</op:service-description>

<op:service-id>org.openmobilealliance:PoC-alert</op:service-id>
<op:version>1.0</op:version>
<op:description>PoC Alert Service v1.0</op:description>

</op:service-description>
<!—- User ‘Bob’ contact means... -->
<contact priority=”0.90”>sip:bob@example.com</contact>
<!—- User ‘Bob’ deviceID... -->
<pdm:deviceID>urn:uuid:d27459b7-8213-4395-aa77-ed859</pdm:deviceID>
<timestamp>2007-02-22T20:07:07Z</timestamp>

</tuple>

<!-- Additional service tuple for PoC-Alert... -->
<tuple id=”a1233”>

<status>

<basic>open</basic>

</status>
<op:willingness>

<op:basic>open</op:basic>

</op:willingness>
<op:registration-state>active</op:registration-state>
<caps:servcaps>

<caps:audio>true</caps:audio>
<caps:text>true</caps:audio>
<caps:video>false</caps:video>

</caps:servcaps>
...
</op:service-description>

<op:service-id>org.openmobilealliance:PoC-alert</op:service-id>
<op:version>1.0</op:version>
<op:description>PoC Alert Service v1.0</op:description>

</op:service-description>
<contact priority=”0.90”>sip:bob@example.com</contact>
<pdm:deviceID>urn:uuid:d27459b7-8213-4395-aa77-ed859</pdm:deviceID>
<timestamp>2007-02-22T22:07:27Z</timestamp>

</tuple>
<!-- Person definition for Bob (as authorized for class ‘forFriends’... -->
<pdm:person id=”a1234”>

<!-- Activities (meeting)... -->
<rpid:activities>

<rpid:meeting/>

</rpid:activities>
<rpid:class>forFriends</rpid:class>
<!-- Place Additional service tuple for PoC-Alert... -->
<rpid:place-type> <lt:office/> </rpid:place-type>
<pdm:timestamp>2007-02-22T22:07:07Z</pdm:timestamp>

</pdm:person>
<!-- Device associated with PoC-Alert... -->
<pdm:device id=”a1235”>

<op:network-availability>

<op:network id=”IMS”>

<op:active>

</op:network>

</op:network-availability>
<pdm:deviceID>urn:uuid:d27459b7-8213-4395-aa77-ed859</pdm:deviceID>
<pdm:timestamp>2007-02-22T22:07:07Z</pdm:timestamp>

</pdm:device>

</presence>

The above therefore illustrates the large (in terms of number of bytes or characters) presence document that is returned, requiring significant battery resources to receive and network resources to transmit.

As will be appreciated by those skilled in the art, the resulting ‘raw presence document’ illustrated above could also be delivered by an OMA/Presence SIP:NOTIFY request (on behalf of an authorized watcher). An XDM fetch is used to simplify the network flows for this example.

Reference is now made to FIG. 9. FIG. 9 shows a process on a mobile device when a context aware layer (P/CAM) is utilized. The method of FIG. 9 replaces that of FIG. 2.

In FIG. 9, the process starts at block 910 and proceeds to block 912 in which the P/CAM is invoked to establish a ‘reachable’ presence aspect for ‘Bob’ and service ‘PoC Alert’. Block 912 waits for the P/CAM to return a result and based on the result the process proceeds to block 920, which indicates ‘Bob-unreachable’, and ends at block 922, or the process proceeds to block 930 which indicates ‘Bob reachable’ and ends at block 932.

As will be appreciated from the above, reachability within a PoC alert client is now a single processing block (reachable/unreachable). It should be noted that the number of processing blocks for a given context aware application remains constant, regardless of the complexity and number of presence related functionalities associated with that application or service.

Comparing network bandwidth requirements between the traditional PoC client application outlined in FIG. 2, and the context aware client application in FIG. 9, an order of magnitude reduction in network overhead is provided. Comparing an XDM fetch using raw presence information for the traditional PoC client, with a SOAP method invocation (as an example deployment scenario) for the context aware ‘reachable’ presence aspect, the following is an example of a request:

POST /CAM-1 HTTP/1.1
...
HOST: pcam.example.com
Content-Type: text/xml; charset=“utf-8”
...
<!-- SOAP request... -->
<SOAP-ENV:Envelope

xmlns:SOAP-ENV=“http://schemas.xmlsoap.org/soap/envelope/”

SOAP-ENV:encodingStyle=“http://schemas.xmlsoap.org/soap/encoding/”>
<SOAP-ENV:Body>

<pcam:reachable xmlns:pcam=“http://pcam.example.com/wsdl/oma-pres-pcam”>

<aor>sip:bob@example.com</aor>
<service>org.openmobilealliance:PoC-alert</service>

</pcam:reachable>

</SOAP-ENV:Body>

</SOAP-ENV:Envelope>

The following is an example of a response:

HTTP/1.1 200/OK
Connection: close
...
Content-Type: text/xml; charset=“utf-8”
...
<!-- SOAP response... -->
<SOAP-ENV:Envelope

xmlns:SOAP-ENV=“http://schemas.xmlsoap.org/soap/envelope/”
SOAP-ENV:encodingStyle=“http://schemas.xmlsoap.org/soap/encoding/”>
<SOAP-ENV:Body>

<pcam:reachableResp xmlns:pcam=“http://pcam.example.com/wsdl/oma-pres-pcam”>

<result>reachable</result>

</pcam:reachable>

</SOAP-ENV:Body>

</SOAP-ENV:Envelope>

The above therefore illustrates the reduction in data required to be transferred and also the reduction in processing required by a client.

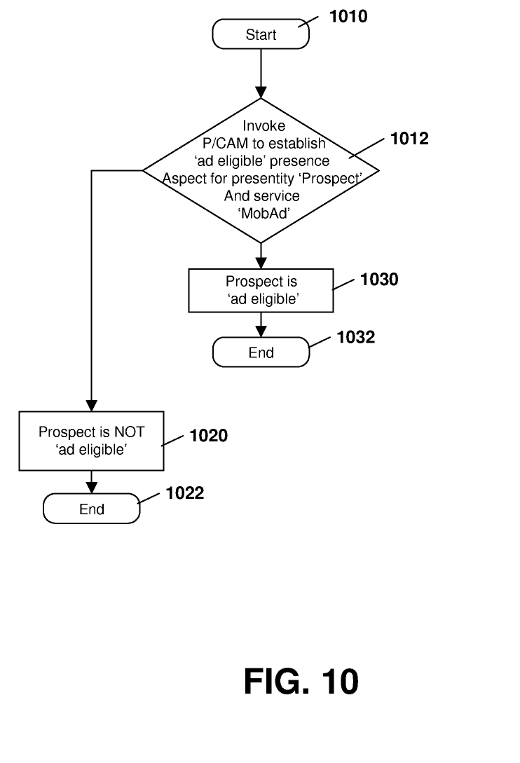

A further example is illustrated below with reference to FIG. 10. FIG. 10 is provided to show the example where an ad Agency ‘Ad-Inc.’ wishes to reach consumers with a generic mobile advertising campaign. Ad-Inc. would like to optimize delivery of advertisements to the resource constrained devices based on specific criteria. For example, the ad-campaign consists of small video sequences, therefore the device must be reachable, have specific media capabilities, and have a modicum of battery level so that the ads can i) render properly on the device and ii) will not cause the device to lose significant battery so as to upset the prospective consumer and cause a negative association between the brand(s) being campaigned and the loss of a device. A mobile advertising enabler “MobAd” specifies a new presence aspect known as ‘ad-eligibility’ to the P/CAM through the introduction of a Policy (e.g. PEEM/PEL) ‘process’ document with suitable logic flows. Similarly or in combination, the MobAd application could specify a location aspect.

In FIG. 10, the process starts at block 1010 and proceeds to block 912 in which the P/CAM is invoked to establish the device is ‘ad eligible’, the presence aspect for the presentity prospect and the service ‘MobAd’.

Block 1012 waits for a response from the P/CAM and depending on the result proceeds to block 1020 in which the prospect is deemed NOT ‘ad eligible’. The process proceeds to block 1022 from block 1020 and ends.

Conversely, from block 1012, the process could proceed to block 1030 if the result from the P/CAM deems the prospect to be ‘ad eligible’. As will be appreciated, ‘ad eligible’ could be considered a specific variant of the aspect ‘eligible-session-participant’ as defined in Table 2 above. The process then proceeds to block 1032 and ends.

The processing blocks related to the MobAd ad-eligibility presence aspect in FIG. 10 is significantly less than would be required by a stand-alone MobAd agent or client processing this metadata on its own. Additional complexity would need to be added over and above the logic flow shown in FIG. 2 to support the additional logic of resolving a threshold policy and media capabilities. This logic instead is incorporated as a new presence aspect (presence aspect building block) within a context aware layer and tied together to compute contextual presence on behalf of MobAd (ad-eligibility).

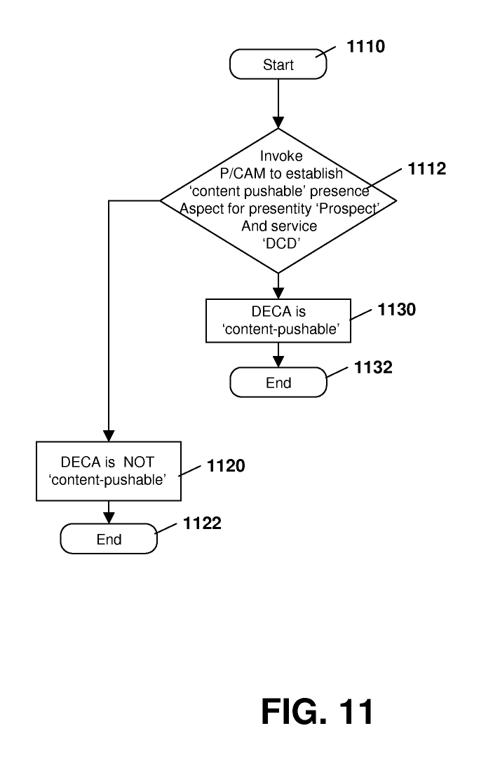

A further example is illustrated with reference to FIG. 11. FIG. 11 illustrates the example a scenario in which a dynamic content delivery (DCD) Server wishes to send DCD content to a DCD enabled client application (DECA) via a DCD Client residing on a user's device. The DCD Server is considered a watcher of the DCD enabled client application (a presentity). The DCD Server would only like to send content to the associated DCD enabled client application if that DCD client is reachable and the storage capacity of the associated device is above a predefined minimal memory threshold after the DCD client has pushed the content. DCD establishes a new presence aspect known as ‘content-pushable’ to the P/CAM by introducing a PEEM/PEL ‘process’ document with suitable logic flows. Again, this is analogous to the ‘eligible-session-participant’ aspect, except here the criteria or aspect has been overridden for the specific functionality associated with a DCD enabler. In the present case the client is reachable, and has a given storage-free capacity.

Referring to FIG. 11, the process starts at block 1110. The process then proceeds to block 1112 in which the P/CAM is invoked to establish ‘content pushable’ presence aspect for presentity ‘Prospect’ and service ‘DOD’. A result from the P/CAM determines whether the process proceeds to block 1120 and decides that the DECA is not ‘content pushable’ or to block 1130 and decides that the DECA is ‘content pushable’.

The process proceeds to block 1122 or block 1132 from blocks 1120 and 1130 respectively, and ends.

The processing blocks related to the DCD content-pushable presence aspect in FIG. 11 are executed by the P/CAM and the DCD Server only needs to invoke the rule in the P/CAM providing input parameters such as deviceID, service-id, and content-size. This rule can now be incorporated as a new presence aspect (presence aspect building block) within P/CAM and tied together to compute contextual presence on behalf of DCD (content-pushable).

Rules, policy types, and applicable policy values may also be used to resolve indeterminate states that may arise when publishing data. Information sources (e.g. a Presence Server, PS) accept the publication of data on behalf of logical entities (e.g. people). This information is later shared with information consumers who have interest in that logical entity (e.g. watchers). Other examples of information sources might be a location service, a mobile advertising platform, a social network, a network monitoring service, etc. One issue that arises with the relay of information is guaranteeing that ‘state’ associated with that information (for both direct or inferred information) is consistent and can be absorbed appropriately by the info-consumer.

If for example, the entity incorrectly publishes information or does not follow appropriate protocol(s) for the associated service, and data is omitted or never published, a gap in the data feed or information flow is created. Currently the onus falls on the info-consumer or watcher to make determinations about these data gaps. This typically involves making a determination of ‘state’ in a vacuum without any guidance from the associated service that exposed the information (i.e. the PS). This leads to inconsistent conclusions as well as invalid inferences regarding the status or state of the entity being observed, which can have a ripple effect. For example, an information consumer (watcher) contacting an individual who is unable or unwilling to receive a communication session.

An example of how indeterminate states can be reached is discussed. An Open Mobile Alliance Presence (PRS) compliant platform contains a facility for the receipt of presence information on behalf of authorized presentities. The PRS platform later shares this information (based on Policy) to authorized observers (watcher subscribers). There are several scenarios where it is possible for indeterminate information to be published by a presentity.

### EXAMPLES

1. Presentity fails or omits a publication (either in whole or in part) when their ‘current’ status has changed;
2. Presentity erroneously publishes Presence Information to the OMA PS;
3. Presentity publishes correct Presence Information, however data published results in an indeterminate state(s) by virtue of a gap or issue in the underlying publication format;
4. Presentity common-policy results in an indeterminate Presence Information document relayed to one (or more) info-consumers (watchers);
5. A combination of any of 1 to 4.

Looking at #1 and #3 (and by combination, #5) in the previous examples in more detail, it can be seen how it is possible for the watcher to reach an indeterminate (or inconsistent) conclusion regarding the state of the associated watcher. A presentity ‘Bob’ has previously published both a Presence Information document along with a common-policy document. The common-policy contains one or more rules which permit a client, in this case an IM client (or watcher) to subscribe to this Presence Information, and to view specific information such as his entire ‘Person’ information, along with all service/device tuples relating to Instant Messaging (IM) service(s). One particular presence indicator is ‘willingness’. As defined by the Open Mobile Alliance, ‘willingness’ is an indicator of whether the associated presentity is willing to communicate. There are at least two specific ‘paths’ which result in this ‘indeterminate’ or ‘inconclusive willingness’:
Presentity ‘Bob’ did not publish ‘overriding-willingness’ in his person tuple, and failed to publish any ‘IM’ service tuples that the IM client could see;
Presentity ‘Bob’ did not publish ‘overriding-willingness’ in his person tuple and also omitted the publication of ‘app-specific-willingness’ from within an applicable IM service tuple.

Both paths (noted above) are considered by OMA Presence, to be ‘valid’ Presence Information publications. Therefore, a watcher-agent (e.g. a smart phone mobile wireless device running an IM service) operating as the IM client on receipt of this raw presence information, is left to make an inconclusive decision about whether ‘Bob’ can be contacted. The watcher, or IM client, has a 50% chance of making the correct assumption with respect to Bob's willingness (i.e. he may be willing, or he may be unwilling).

Resolving these data gaps in a consistent manner may be achieved through the use of a policy mechanism which specifies, identifies or defines a set of extensible policy types and resulting values. In one embodiment this policy mechanism is implemented in a context aware middleware or proxy component (e.g. a Presence Service, a Location Service, etc.) to resolve indeterminate states on behalf of an information consumer.

One solution makes use of a rules based mechanism which operates on behalf of the information consumer by processing published information to provide useful information which is consistent and determinate. This is achieved through the execution of rules which are specifically designed to recognize indeterminate state indicators, and to resolve these as appropriate for the associated service. This solution also moves the decision point about indeterminate states closer to (or at) the service offering the information, helping to guarantee that an information consumer always receives determinate state information on behalf of the publisher.

The rule based mechanism or algorithm uses the presence aspect ‘willingness’ on behalf of an information consumer to provide a mechanism for repeatedly calculating consistent and determinate ‘willingness’ indicators on behalf of any Presence Information publishers and their associated info-consumers. This capability results in consistent and determinate information being supplied to the information consumer. The info-consumer is not left with a scenario in which it must ‘choose’, ‘guess’ or ‘hypothesize’ the result.

It should also be noted that this solution supports the variation and inclusion of policy types and/or values as needed. For example, this may include resolving indeterminate paths, providing default values when none exist, or supporting rules processing directives at critical junctures. That is, the mechanism may dynamically resolve applicable policy types/values (and rules) based on several factors including:
Service-Id (e.g. apply specific policy-types/values for IM vs. Push-to-Talk)
User (e.g. apply or add specific policy-values for user ‘Bob’)
Group (e.g. apply a specific set of rules, policy-types/values for the ‘Executive’ group)

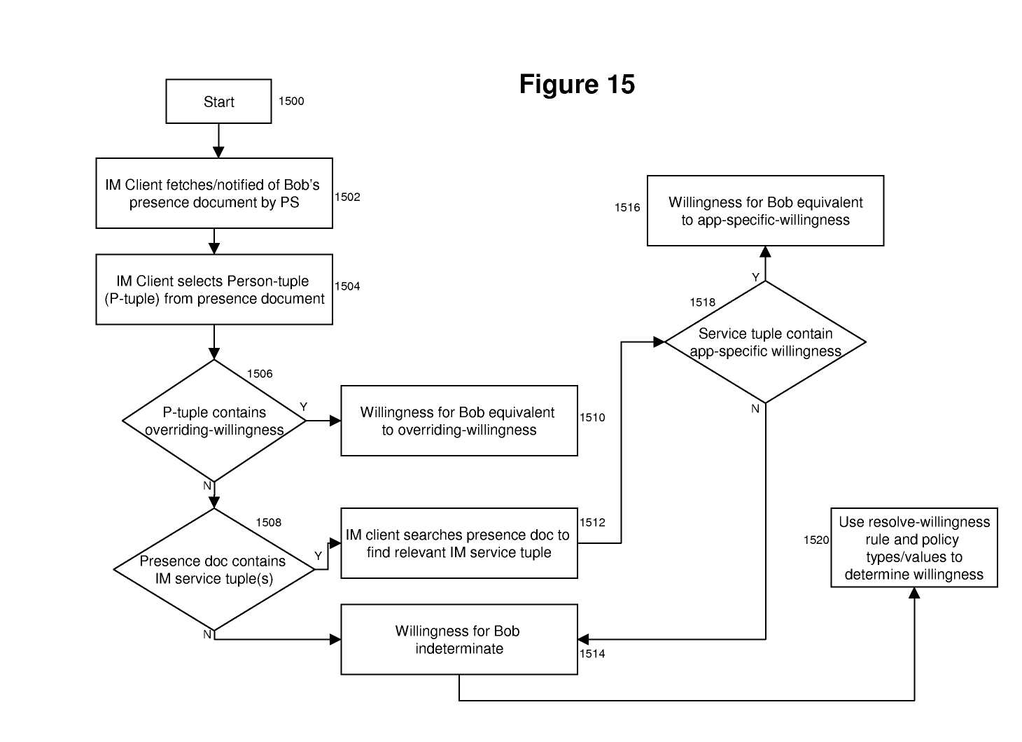

Referring now to FIG. 15, the process is started at block 1500 which corresponds to a presentity (called Bob in this example) making themselves known to the network (e.g. through a presence publication to a presence service). Continuing into block 1502, a client wants information about Bob. In this example, the client is an IM client and the proposed target action is to set up an IM session with Bob. However, the solutions described herein apply to the resolution of any indeterminate presentity state.

The IM client either asks for and receives Bob's presence document from the PS, or, the PS has notified the IM client of Bob's presence document upon receiving a presence publication from Bob as shown in block 1502.

Continuing into block 1504, the IM client processes the presence document for a person-tuple (p-tuple). Continuing into decision point 1506, the p-tuple is checked for the state called “overriding-willingness”, which indicates whether a contact is ‘willing’ (status-indicator=‘open’) or ‘unwilling’ (status-indicator=‘closed’) regardless of how other relevant tuples may be set. If there is an overriding-willingness p-tuple element set, then the “Y” exit is taken to block 1510.

The actions associated with block 1510 are those needed to continue with the establishment of an IM session between Bob and the IM client based on the existence of the “overriding-willingness” element in a p-tuple, the p-tuple found in Bob's presence document (i.e. either ‘open’ which means ‘willing’ or ‘closed’ which means ‘unwilling’). As will be appreciated, as a result of the processing aspect ‘willingness’ is complete.

Returning to decision point 1506, if there is no overriding-willingness in a p-tuple, then the “N” path is taken to decision point 1508. The actions associated with decision point 1508 are those to determine if Bob's presence document contains tuples specifically addressing the service being requested by the client. In this example, the client is an IM client, so the presence document is checked for tuples relating to an IM service (e.g. by service description/identity). If there are any tuples relating to IM service, decision point 1508 is left from its “Y” exit for block 1512.

The actions associated with block 1512 include those carried out by the IM client to determine the most relevant IM service tuple(s). Block 1512 is then left for decision point 1518.

The actions associated with decision point 1518 include the assessment of the IM-specific tuples to determine if any of the tuples, or one or more element(s) therein, are set to allow an IM connection to Bob (i.e. Bob is willing to receive incoming IM service requests). If the answer is yes, The “Y” exit is taken to block 1516. The logic associated with block 1516 includes the equating of the IM-specific session allowance to willingness, further used to set up an IM session between the IM client and Bob. At block 1516 the processing of aspect ‘willingness’ is complete.

Returning to decision point 1518, if there are no tuples or elements therein which indicate the willingness (or in some cases the ability, which logically equate to the same state setting) to receive an IM session, the “N” exit is taken to block 1514. Block 1514 is a block representing a temporary state where, at this point in the algorithm, Bob's willingness state is unknown, inconclusive or indeterminate.

Returning to decision point 1508, if the presence document being processed by the client contains no service-specific tuples (in this example, if Bob's presence document does not contain any IM-specific tuples), then the “N” exit is taken to block 1514. Block 1514 is a block representing a temporary state where, at this point in the algorithm, Bob's willingness state is unknown.

Block 1514 is left for block 1520. The actions associated with block 1520 are those needed to resolve the indeterminate willingness state. The indeterminate state is resolved using a rule or logic sequence called resolve_willingness (R-U). R-U makes use of the defined policy values, including ‘undef-willingness’, and possibly ‘opt-in-source’, etc., to establish a determinate ‘willingness’ result on behalf of the IM client or watcher.

One example of an algorithm to determine ‘willingness’ for the example of FIG. 15 is as follows:

1. willingness = policy_defined(‘undef-willingness’, serviceId)
2. if (willingness undefined)
2.a return default ‘undef-willingness’ value {closed, indefinite}
3. else
3.a return willingness

The above algorithm will lookup or resolve (e.g. in the PAL case from OMA/PEEM (policy evaluation, enforcement and management) Policy Expression Language—PEL) the applicable policy value for the given type (‘undef-willingness’) and the associated serviceId (e.g. IM). Such resolution is described, for example with regard to Table 1, above.

Continuing with the algorithm, if a willingness value is defined, return that (as seen in 3.a). Otherwise, the algorithm needs to establish a default value for the type {closed, indefinite} (as seen in 2.a). One such value could mean that the presentity is unwilling for an indefinite period, such as forever.

Another alternative embodiment is to locate the rules processing or rules evaluation either within the information providing service itself (e.g. within a network) or on the client device (e.g. on behalf of one or more applications making use of the underlying information on a wireless terminal). For example, a location service which supports applications such as Google Maps™, a navigation program like Garmin™, and a Chat program which makes use of ‘proximity’ information could be enhanced either at the network service level or using a client component (on the device) to intercept information outflows, and to apply (where applicable) a combination of rules/policy-types/policies to indeterminate or inconsistent information. This is applicable with or without a P/CAM.

The above is illustrated in the examples below.

Instant Messaging Client

One exemplary client application for the use of a context aware layer is an instant messaging application. The instant messaging application is called “MyFriendlyChat” herein.

In a university setting, for example, several friends may have the “MyFriendlyChat” application loaded onto their mobile device. In this example, user Alice is a university student returning to college after a day of classes. She is heading towards the college restaurant and wonders whether any of her friends are nearby to join her for dinner.

Alice takes out her wireless device and starts the “MyFriendlyChat” application and invokes the “Invite-nearby-friends-to-chat” function. This function utilizes both presence and location to return a list of friends that are within a predetermined distance and have a reachable status. The “MyFriendlyChat” application returns the active buddy list showing that Bob and Jane are nearby and reachable.

Alice enters a short message on her device letting her friends know that she is going to the college restaurant. Both Bob and Jane reply that they will join her shortly.

The above shows a client application which utilizes both presence and location in order to make determinations and return relevant information to a user. In particular, the “invite-nearby-friends-to-chat” function requires knowledge of the location of nearby friends, as well as presence information to allow the instant messaging to occur.

Under a traditional model of instant messaging, a presence platform will need to be queried to obtain a list of raw data which must then be processed by the client application. Further, in this case a location platform would also be required to be queried to find the location of individuals in a buddy list.

According to the present disclosure, the aspects can be abstracted to a context aware layer that is located within the network. The context aware layer can be part of a platform such as the location and presence platform, part of a dedicated server, part of a presence or location server, or could be distributed among these entities. In some cases an agent for the context aware layer could also exist on the wireless device or on another computer.

The functionality of the client application is placed within the context aware layer thus providing for consistent results between varied client applications and also reducing signaling between the mobile device and network.

For the above, the “MyFriendlyChat” client application functions as both a watcher and a presence source in an OMA/PRS realization and functions as a presence source in a context aware layer realization.

The context aware layer makes use of a predefined aspect to determine whether Bob and Jane can be reached. In this case, the aspect may be “eligible-session-participant” which is defined to select one or more presentities based on a given criteria. In this case, the aspect “eligible-session-participant” is overridden for application “MyFriendlyChat” to select from a group list those “buddies” who are “willing, reachable, and nearby”. The overridden presence aspect is configured prior to the indication of any aspects from a “MyFriendlyChat” client executing on the wireless device.

With regard to call flows, the client application must determine who is willing, reachable, and nearby to initiate a message datagram to invite these “buddies” to dinner. To fulfill this functionality, it is assumed that the “MyFriendlyChat” application subscribes to members of Alice's buddy list through OMA PRS/RLS components.

The client application thereafter needs only initiate communications towards eligible session participants based on the context aware layer result.

Various rules could be applied to the aspect to narrow it further. For example a limit could be placed on a subset of buddies when determining who is close by and reachable. Thus, the rule could be that only university buddies are returned when the request is made.

In a continuation of the above example, once Alice, Bob and Jane reach the restaurant, Alice could set an aspect trigger on her mobile device to alert her if any of her friends come within a certain distance of the restaurant within a predetermined time period. For example, Alice could set a trigger on her device to indicate that if any “buddies” come within 0.5 kilometers within the next half hour she should be alerted.

In this example, Jim meets these criteria and Alice receives a notification on her mobile device that Jim has entered the specified area and Alice can thus invite Jim to join the group.

As will be appreciated the above illustrates an example of an aspect trigger. Specifically, a trigger is established for the aspect “eligible-session-participant” and can be called, for example, “is EligibleSession Participant” which could cause an alert to be sent to Alice once true. As will be appreciated, such an alert could include an audible tone, vibration or any such notification to indicate to a user that the trigger conditions have been met.

Again, the use of a context aware layer facilitates a use of triggers, as well as reducing communications between the mobile device and the network, thereby saving battery live on the mobile device and network resources.

Mobile Advertising Scenario

In a further example of the above, car company XYZ Motor Cars wants an advertising campaign to coincide with the launch of a new sports-activity car model. XYZ Motor Cars hires Split-second Advertising Company to run the ad campaign and Split-second makes use of ABC Telecom as the wireless service/content delivery provider.

Split-second has established an advertising campaign for the new car model targeting individuals between 23 and 30 years of age with interests in biking, camping, kayaking. The ad contains various photos, video-clips or the like, of the new model being used with different sports activities.

Jack, Phyllis, Lynn and George have all agreed to receive advertising related content. Andrew is within the target market for XYZ Motors but has not opted to receive advertising content. Jack, Lynn and George are within the target market for XYZ Motors.

With the above scenario, ABC Advertising Company configures their wireless advertising platform for the advertising campaign. A trigger is established within the wireless advertising platform, where the trigger monitors individuals who meet the Split-second criteria for the given ad campaign, who have opted in to receive the advertising, are “reachable”, and have an appropriate device with capabilities of receiving an associated video clip.

ABC turns on the campaign to coincide with the launch date of the new model for XYZ, resulting in the context aware layer trigger, defined above, firing.

A short time later, Jack, Lynn and George receive messages containing information related to the new vehicle being introduced by XYZ Motors. The ad content is adapted appropriately for each device. For example, Jack could receive a WAP-Push SMS with the WAP-URL to XYZ Motor's launch site while Lynn and George both receive multi-media messages (MMS) with a short video clip attached.

Since Phyllis and Andrew did not meet the criteria for the ad campaign, they are not contacted. However, if at a future time but still during the ad campaign, Andrew opts in to receive wireless advertising messages the XYZ Motor Company ad would be sent to Andrew.

The above is implemented utilizing various aspects. The “reachable” aspect can be used to determine whether Jack, Lynn and George can be reached to send advertising messages to. An aspect such as “opt-in” can be used to determine whether the user has opted in to receive advertising.

Triggers could also be utilized. In this case, a trigger such as “is EligibleSessionParticipant” is used to return one or more users who have opted into the wireless advertising and content delivery services, are reachable and have a device with an appropriate set of media capabilities. In this case, the default action for the aspect trigger could be to direct the context aware layer to initiate content appropriate to the user. Thus, for example, no direct over-the-air indication could be sent to an advertising application on the client device.

The context aware layer could include information such as MobileAdvertisingPreferences” defining a collection of mobile advertising specific preferences stored in an appropriate XDMS. The wireless advertising client located in the device may invoke this entity to return mobile advertising related preferences.

Other information could include “ContentDeliveryPreferences” having a collection of content-delivery preferences stored in an appropriate XDMS. The wireless advertising client or other component within the device may invoke this entity to return content-delivery/service/application/device preferences.

The advertising example provides for a context aware layer utilizing two separate enablers working together. Specifically a mobile advertising and content delivery enabler are used to achieve a specific function point. Such interactions are not possible under present services.

Research has shown that data transfer savings utilizing a context aware layer are between 40 and 75% under certain conditions. Thus, the use of the context aware layer provides savings of network resources and battery life on the mobile device.

The context aware layer further provides for the connection of multiple and varied client applications by allowing aspects, rules, policies and triggers to be defined at the context aware layer. This provides the advantage that the context aware layer can service multiple client applications and does not need to be recreated for each specific client application. Further, the context aware layer provides a unique perspective of the information sources (as shown above) on behalf of a client based on factors such as the service, who the client is (i.e. their identity), what service group or class of service they belong to, and possibly other factors.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

1. A method for resolution of indeterminate or inconsistent information on behalf of an information consumer, the method comprising:
using a processor of a middleware component to determine whether information for the information consumer is resolvable; and
if the information is determined to be unresolvable, utilizing at least one of rules, policy types and policy values specified by a context to resolve the information.

2. The method of claim 1 wherein the information is designated for the information consumer by a service associated with the context.

3. The method of claim 1, wherein the using comprises determining if a target fails to publish a change in status.

4. The method of claim 1, wherein the using comprises determining if a target publishes erroneous information.

5. The method of claim 1, wherein the using comprises comparing data published by a target with an underlying publication format to identify a gap in the data.

6. The method of claim 5 wherein the comparing comprises identifying the gap based on semantics or publication specification of the underlying publication format.

7. The method of claim 1, wherein the utilizing comprises providing a default or fallback value for the information.

8. The method of claim 7, wherein the default or fallback value is an indeterminate information document.

9. The method of claim 1, wherein the utilizing comprises overcoming the unresolvable information according to rule processing for the information.

10. The method of claim 9, wherein the utilizing further comprises overcoming the unresolvable information according to data semantics.

11. The method of claim 1, wherein the utilizing comprises resolving indeterminate paths.

12. The method of claim 1, wherein the middleware component is at least one of a presence service and a location service.

13. The method of claim 1, wherein the desired information is an Open Mobile Alliance presence or location aspect.

14. The method of claim 1, wherein the using comprises determining whether desired information exists or is specified by at least one of a target, an application or a service provider.

15. The method of claim 1, wherein the utilizing comprises employing at least one factor selected from the group consisting of: a service identifier; a specific information consumer; and a group the information consumer belongs to.

16. A middleware component configured to resolve indeterminate or inconsistent information for an information consumer, comprising:
a processor configured to:
determine whether information for the information consumer is resolvable; and
if the information is determined to be unresolvable, utilize at least one of rules, policy types and policy values specified by a context to resolve the information.

14. The middleware component of claim 13, wherein the middleware component is at least one of a presence service and a location service.

15. The middleware component of claim 13, wherein the middleware component is a proxy.
